(19) United States
(12) Patent Application Publication
(10) Pub. No.: US 2026/0340312 A1
(43) Pub. Date: Oct. 29, 2026

(54) SYSTEM, CONTROL METHOD, AND RECORDING MEDIUM

(71) Applicant: SHARP KABUSHIKI KAISHA, Sakai City (JP)

(72) Inventors: Nao TAKEUCHI, Sakai City (JP); KATSUYOSHI KONDOH, Sakai City, (JP); HIROKI MUNETOMO, Sakai City, (JP)

(21) Appl. No.: 19/659,011

(22) Filed: Apr. 27, 2026

(30) Foreign Application Priority Data
Apr. 28, 2025 (JP) 2025-074917

(51) Int. Cl. G06F 40/40; H04N 1/00

(52) U.S. Cl. CPC G06F 40/40; H04N 1/00037; H04N 1/00079; H04N 1/00244

(57) ABSTRACT

A system includes: a status information acquirer that acquires status information of an information processing apparatus; a receiver that receives an input sentence; an answer acquirer that acquires an answer sentence from a large language model based on the input sentence; and an outputter that outputs the answer sentence or a notification, wherein the outputter outputs an answer sentence including the status information of the information processing apparatus when the input sentence is an inquiry about a status of the information processing apparatus.

### CROSS-REFERENCE TO RELATED APPLICATION

The present application claims priority from Japanese Application JP2025-074917, the content to which is hereby incorporated by reference into this application.

### BACKGROUND OF THE INVENTION

### 1. FIELD OF THE INVENTION

The disclosure relates to a system and the like.

### 2. DESCRIPTION OF THE RELATED ART

In the related art, a system has been known in which, when an error occurs in an image forming apparatus, a two-dimensional code displayed on the operation screen of the image forming apparatus is read into a terminal apparatus, and explanatory information corresponding to the error is displayed on the display screen of the terminal apparatus.

### SUMMARY

An object of the disclosure is to provide, for example, a system that can provide an appropriate answer in accordance with an input sentence input by a user.

A system according to the disclosure includes: a status information acquirer that acquires status information of an information processing apparatus; a receiver that receives an input sentence; an answer acquirer that acquires an answer sentence from a large language model; and an outputter that outputs the answer sentence or a notification, in which the outputter outputs an answer sentence including the status information of the information processing apparatus when the input sentence is an inquiry about a status of the information processing apparatus.

A system according to the disclosure is a system including an information processing apparatus, a terminal apparatus, and a server apparatus, in which the information processing apparatus transmits status information of the information processing apparatus to the server apparatus, the terminal apparatus receives an input sentence and transmits the input sentence to the server apparatus, the server apparatus acquires an answer sentence based on the input sentence from a large language model, the server apparatus transmits the answer sentence to the terminal apparatus, and the terminal apparatus outputs an answer sentence including the status information of the information processing apparatus when the input sentence is an inquiry about a status of the information processing apparatus.

A control method according to the disclosure includes: acquiring status information of an information processing apparatus; receiving an input sentence; acquiring an answer sentence from a large language model; and outputting the answer sentence or a notification, in which the outputting includes outputting an answer sentence including the status information of the information processing apparatus when the input sentence is an inquiry about a status of the information processing apparatus.

A non-transitory computer-readable recording medium having a program according to the disclosure recorded thereon causes a computer to implement: a status information acquisition function of acquiring status information of an information processing apparatus; a reception function of receiving an input sentence; an answer acquisition function of acquiring an answer sentence from a large language model; and an output function of outputting the answer sentence or a notification, in which the output function includes outputting an answer sentence including the status information of the information processing apparatus when the input sentence is an inquiry about a status of the information processing apparatus.

According to the disclosure, it is possible to provide, for example, a system that can provide an appropriate answer in accordance with an input sentence input by a user.

### BRIEF DESCRIPTION OF THE DRAWINGS

FIG. 1 is a diagram illustrating a configuration of a system according to a first embodiment.

FIG. 2 is a diagram for describing the difference between examples of known answer sentences to input sentences in the first embodiment and examples of answer sentences in the first embodiment.

FIG. 3 is a diagram illustrating a hardware configuration of the system according to the first embodiment.

FIG. 4 is a diagram illustrating a hardware configuration of the system according to the first embodiment.

FIG. 5A is a diagram illustrating a software configuration of the system according to the first embodiment.

FIG. 5B is a diagram illustrating a software configuration of the system according to the first embodiment.

FIG. 6A is a diagram illustrating a software configuration of the system according to the first embodiment.

FIG. 6B is a diagram illustrating a software configuration of the system according to the first embodiment.

FIG. 7A is a diagram illustrating an example of model information in the first embodiment.

FIG. 7B is a diagram illustrating an example of status information in the first embodiment.

FIG. 8A is a diagram illustrating an example of a prompt requesting category analysis in the first embodiment.

FIG. 8B is a diagram illustrating an example of a prompt requesting an answer sentence in the first embodiment.

FIG. 8C is a diagram illustrating an example of session management information in the first embodiment.

FIG. 9 is a diagram illustrating a flow of processing in the first embodiment.

FIG. 10 is a diagram illustrating a flow of processing in the first embodiment.

FIG. 11 is a diagram illustrating a flow of processing in the first embodiment.

FIG. 12 is a diagram illustrating a flow of processing in the first embodiment.

FIG. 13 is a diagram illustrating a flow of processing in the first embodiment.

FIG. 14A is a diagram illustrating an example of operation in the first embodiment.

FIG. 14B is a diagram illustrating an example of operation in the first embodiment.

FIG. 15A is a diagram illustrating an example of operation in the first embodiment.

FIG. 15B is a diagram illustrating an example of operation in the first embodiment.

FIG. 15C is a diagram illustrating an example of operation in the first embodiment.

FIG. 15D is a diagram illustrating an example of operation in the first embodiment.

FIG. 16 is a diagram illustrating a flow of processing in a second embodiment.

FIG. 17A is a diagram illustrating an example of operation in the second embodiment.

FIG. 17B is a diagram illustrating an example of operation in the second embodiment.

FIG. 18 is a diagram illustrating a flow of processing in a third embodiment.

FIG. 19 is a diagram illustrating a flow of processing in the third embodiment.

FIG. 20 is a diagram illustrating a flow of processing in a fourth embodiment.

### DETAILED DESCRIPTION OF THE INVENTION

When an end user does not know an operation method for an information processing apparatus or when a malfunction occurs, and searches for frequently asked questions (FAQs) or a user manual on the manufacturer’s support homepage, there is a problem in that the user cannot find the operation method if the input search words do not exactly match the wording in the database. Publicly available large language models (LLMs) allow natural language searches, but in this case, the range of general information included in the large language models is limited.

Therefore, “retrieval-augmented generation (RAG)” is known as a method of adding information necessary for a question to be posed to a large language model, providing the information and the question to the large language model, and obtaining an appropriate answer. RAG creates a database that compiles document information prepared in advance, selects the necessary document information, such as FAQs or manuals, based on the content of the question (for example, search words), and outputs the document information along with the question to a large language model. RAG does not require the preparation of large amounts of training data, and the files themselves are sufficient. Even when the contents of the document information are updated, the updated files are overwritten and stored in the folder that includes them, and the database is reconstructed, allowing the large language model to respond with the new content.

However, when a user asks a question inquiring about the status of an information processing apparatus, even when RAG is used, the individual status information of the information processing apparatus is not in the database, and therefore the answer may be, for example, an operation method for displaying the status. The user himself/herself has to refer to the answer to the operation method and check the status on the operation screen of the information processing apparatus, and there has been a problem in that even when RAG is used, the user cannot obtain the appropriate answer he or she desires.

A system that solves such problems will be described below in the following embodiments with reference to the drawings. It is to be noted that the embodiments described below are merely examples for describing the disclosure described in the claims, and the technical scope of the disclosure is not limited to the descriptions of these embodiments.

### 1. First Embodiment

### 1.1 Overall Description

### 1.1.1 System Configuration

Hereinafter, a first embodiment will be described. Note that the first embodiment will be described using the following as an example. In the following embodiment, a case will be described in which the information processing apparatus is applied to an image forming apparatus.

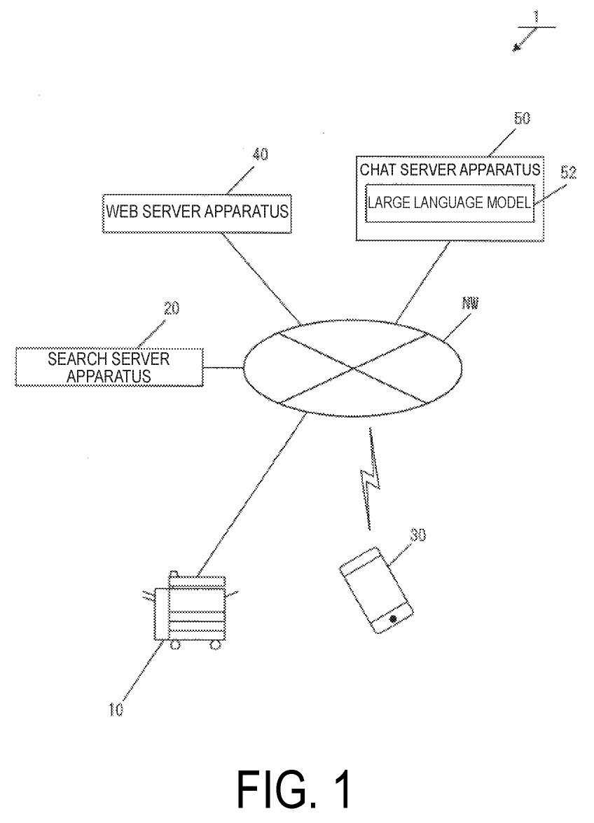

FIG. 1 is a diagram illustrating the configuration of a system 1. In the system 1, an image forming apparatus 10, a search server apparatus 20, a terminal apparatus 30, a web server apparatus 40, and a chat server apparatus 50 are connected via a network NW.

The system 1 provides a chat service to users. A chat service is, for example, a service that enables the interactive transmission and reception of mainly text data via a network. The chat service may also be used to interactively transmit and receive image data and voice data.

The image forming apparatus 10 may be, for example, a printing apparatus, or may be an apparatus called a multifunction peripheral or a multifunction peripheral/printer (MFP). For example, when the image forming apparatus 10 executes a job (print job), it can form an image on paper, which is a recording medium. The image forming apparatus 10 can execute jobs relating to a plurality of functions, such as a copying function, a fax function, a scanning function, and a printing function.

The search server apparatus 20 is a server apparatus that searches for answers to questions based on questions from users and outputs answers including the searched content.

The search server apparatus 20 can acquire knowledge information for each model of the image forming apparatus 10 from the web server apparatus 40, for example. Here, the knowledge information is, for example, information such as user manual information for each model of the image forming apparatus 10 posted on the manufacturer’s homepage, FAQs, and the like.

The terminal apparatus 30 can receive questions about the image forming apparatus 10 from the user using, for example, an application capable of executing a chat function, a web browser, or the like.

The web server apparatus 40 stores knowledge information in a state that can be viewed from a connected apparatus using a user interface such as a web page. The web server apparatus 40 is, for example, an online manual storage apparatus that provides, to users, online manuals for end users on a manufacturer’s support homepage.

The chat server apparatus 50 is a server apparatus that can provide a chat service and may store a large language model 52.

The large language model 52 is one of the language models, and is generally called an LLM. The large language model 52 may be prepared by the service provider that constructs the system 1, or may be provided by using an external service. For example, large language models such as GPT (registered trademark) (Generative Pre-trained Transformers, GPT-3, GPT-4, GPT-4o), PaLM (registered trademark) (Pathways Language Model), LLaMA (Large Language Model Meta AI), and tsuzumi (registered trademark) may be used.

In the embodiment, the system 1 includes the search server apparatus 20, the web server apparatus 40, and the chat server apparatus 50 as separate apparatuses, but may be configured as a single server apparatus, for example. Furthermore, the search server apparatus 20 may have, for example, a language model other than the large language model 52.

The image forming apparatus 10 may be an information processing apparatus such as a smartphone or a tablet. In addition, the apparatus may be a home appliance equipped with IoT functions (for example, an air conditioner, a refrigerator, a television, and the like), or may be a portable apparatus or an in-vehicle apparatus (for example, a car navigation system, and the like).

### 1.1.2 System Overview

The following is a diagram illustrating an overview of the system 1 according to the embodiment. The system 1receives input sentences from the terminal apparatus 30 and outputs output sentences to the terminal apparatus 30.

An input sentence is a message input by a user in the terminal apparatus 30. The input sentence may be, for example, a question sentence including a question about the image forming apparatus 10 from the user. The input sentence may also include content other than questions about the image forming apparatus 10, such as instructions for operating the chat service, such as “make the character larger” or “clear the screen.” In the embodiment, the input sentence is described as a question sentence that includes a question.

An output sentence is a message that the system 1 outputs to the terminal apparatus 30. For example, when the input sentence is a question sentence, the system 1 may output the output sentence to the terminal apparatus 30 as an answer sentence that includes an answer to the question included in the question sentence.

The system 1 may output the output sentence to the terminal apparatus 30 as, for example, a notification sentence including a notification to the user. Here, the system 1 may output the notification sentence based on, for example, the input sentence, or may output the notification sentence without being based on the input sentence.

The system 1 may output the notification to the user to the terminal apparatus 30 in the form of a voice, a figure, an icon, or the like, in addition to a notification sentence.

The icon herein means pictures, pictographs, symbols, and characters displayed on the display screen to represent various types of data and processing functions, for example. When the user selects an icon, a controller 100 can execute the process set in the icon.

When the input sentence is a question sentence, for example, the system 1 may cause the large language model 52 to execute category analysis to specify the category of the input sentence. Here, the category of the input sentence refers to the category of the user’s question included in the input sentence. The category analysis will be described in detail later.

In the embodiment, the large language model 52 generates an analysis result that specifies the category of the user’s question through category analysis, for example, as either a “question about the usage of the apparatus” category or a “question about the status of the apparatus” category.

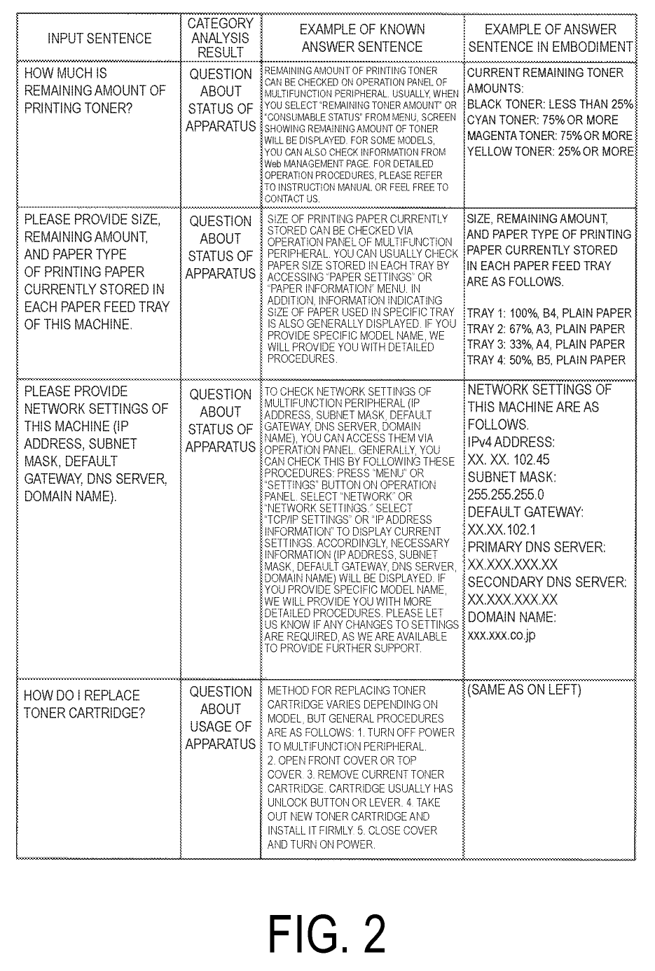

The system 1 generates an answer sentence based on the analysis result generated by the large language model 52. Here, an input sentence received by the system 1 from a user, an answer sentence to the input sentence, and an analysis result of the category analysis of the input sentence will be described with reference to FIG. 2.

FIG. 2 shows an example of an input sentence “How much is the remaining amount of printing toner?” and an analysis result of the category “question about the status of the apparatus.”

Furthermore, FIG. 2 shows an example of a known answer sentence when no category analysis of the input sentence is executed. Here, in the case of the related art, an example is shown in which an answer sentence in the category of “question about the usage of the apparatus” is output, even though the input sentence is “the remaining amount of printing toner can be checked on the operation panel of the multifunction peripheral...,” which is in the category of “question about the status of the apparatus.”

On the other hand, FIG. 2 shows an example of an answer sentence in the embodiment that is output based on a category analysis executed on an input sentence. In the embodiment, in response to an input sentence in the category of “question about the status of the apparatus” such as “Current remaining toner amounts: Black toner: Less than 25%...,” an answer sentence in the category of “question about the status of the apparatus” is output.

In this way, in the embodiment, the system 1 can output the optimal answer sentence desired by the user, in accordance with the content of the input sentence received from the user, by analyzing the category of the input sentence.

### 1.2 Hardware Configuration

### 1.2.1 Common Configuration

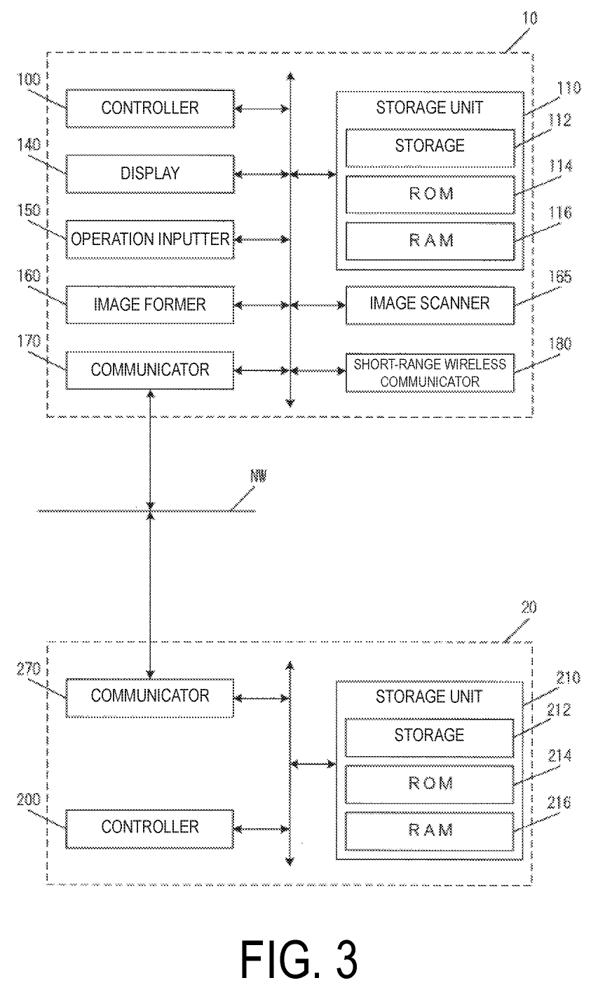

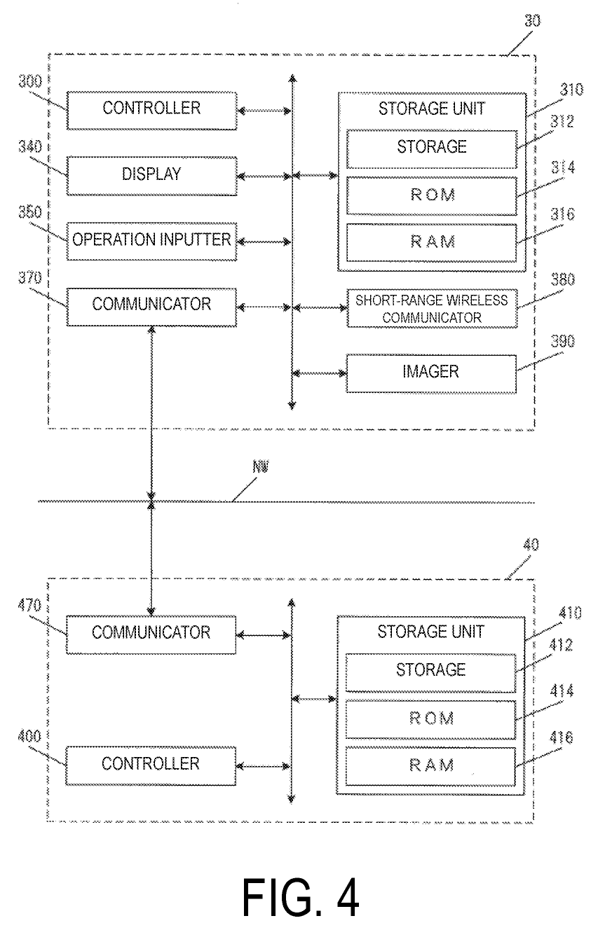

FIGS. 3 and 4 are diagrams illustrating the hardware configuration of each apparatus in the embodiment. The image forming apparatus 10, the search server apparatus 20, the terminal apparatus 30, and the web server apparatus 40 each include at least a controller, a storage unit (a storage, a read only memory (ROM), a random access memory (RAM)), and a communicator. In addition, each of the apparatuses has a general function as necessary.

Here, among the respective apparatuses, a controller, a storage, a ROM, a RAM, a display, an operation inputter, and a communicator will be described below.

The controller (for example, a controller 100, a controller 200, a controller 300, and a controller 400) is a functional unit for controlling the entire apparatus. The controller implements various functions by reading and executing various programs stored in a storage or the ROM. The controller may be implemented by one or more control apparatuses/arithmetic apparatuses (central processing unit (CPU) or system on a chip (SoC)).

The storage unit (for example, a storage unit 110, a storage unit 210, a storage unit 310, and a storage unit 410) is one or more storage apparatuses that store various programs and various types of data required for the operation of the image forming apparatus 10. The storage unit is composed of, for example, a storage, a ROM, a RAM, and the like.

The storage (for example, a storage 112, a storage 212, a storage 312, and a storage 412) is a non-volatile storage apparatus capable of storing programs and data. For example, the storage may be configured with a storage apparatus such as a hard disk drive (HDD) or a solid state drive (SSD). In addition, the storage may also have a configuration such as a Universal Serial Bus (USB) memory that can be connected externally. In addition, the storage component may be, for example, a storage area on a cloud.

The ROM (for example, a ROM 114, a ROM 214, a ROM 314, and a ROM 414) is a non-volatile memory that can retain programs and data even when the power is turned off. The ROM may store, for example, firmware for each apparatus, initial applications, and the like.

The RAM (for example, a RAM 116, a RAM 216, a RAM 316, and a RAM 416) is a main memory that is mainly used by the controller of each apparatus when executing processing. The RAM is a rewritable memory that temporarily stores the storage of each apparatus, programs read from the ROM of each apparatus, and data including the results of execution.

The display (for example, a display 140 and a display 340) is a display apparatus capable of displaying various types of information and various screens such as an execution screen. The display may be, for example, a display apparatus such as a liquid crystal display (LCD), an organic electro-luminescence (EL) display, or an electrophoresis display. In addition, the display includes an interface to which a display apparatus can be connected. For example, the display may include an external display apparatus connected via a high-definition multimedia interface (HDMI; registered trademark), a digital visual interface (DVI), or a display port.

The operation inputters (for example, an operation inputter 150 and an operation inputter 350) are operation apparatuses that can receive operation input from a user administrator or a system administrator. For example, the operation inputter may be software keys displayed on a touch panel integrated with the display or hardware keys such as operation buttons. In addition, the operation inputter may be an operation apparatus such as a keyboard or a mouse. Furthermore, the operation inputter may also include an interface (for example, a USB) to which an operation apparatus can be connected. For example, each apparatus may be connected to different operation apparatuses (keyboard, mouse, and the like) via an interface.

The communicator (for example, a communicator 170, a communicator 270, a communicator 370, and a communicator 470) is a communication interface for communicating with other apparatuses. For example, the communicator may be a network interface connectable to a wireless local area network (LAN), or may be a network interface connectable to Ethernet (registered trademark) in a wired manner. In addition, the communicator may be a communication apparatus connectable to a mobile communication network such as Long Term Evolution (LTE) /4G/5G/6G.

The short-range wireless communicator (for example, a short-range wireless communicator 180 and a short-range wireless communicator 380) is an interface that communicates data with various external apparatuses that can use NFC. The short-range wireless communicator may use, for example, NFC or Bluetooth (registered trademark).

### 1.2.2 Other Configurations

Next, the specific configuration of each apparatus that is not described in [1.2.1] will be described.

An image former 160 in the image forming apparatus 10 in FIG. 3 forms an image on, for example, a recording sheet. The image former 160 includes, for example, an image carrier, and forms an image by forming a toner image on the image carrier and transferring the toner image on the image carrier onto the recording sheet. The image former 160 may be configured as an image forming apparatus such as a printer. The image former 160 may electronically form an image as an image file.

An image scanner 165 in the image forming apparatus 10 in FIG. 3 scans an original (image) and outputs the original as image data. The image scanner 165 is, for example, a scanner, and may be a reading apparatus that utilizes a charge coupled device (CCD), a contact image sensor (CIS), or a complementary metal-oxide-semiconductor (CMOS) image sensor.

An imager 390 in the terminal apparatus 30 in FIG. 4 scans an image and outputs the image as image data. The imager 390 is, for example, a camera, and may be an imaging apparatus that uses a charge coupled device (CCD) or a complementary metal-oxide-semiconductor (CMOS) image sensor. In the embodiment, the terminal apparatus 30 includes the imager 390, but for example, the terminal apparatus 30 may not include the imager 390 and an external camera apparatus or the like may be connected.

The configuration of the chat server apparatus 50 is similar to that of the search server apparatus 20 and the web server apparatus 40, and therefore a detailed description thereof will be omitted. The chat server apparatus 50 includes, for example, at least a controller, a storage unit (a storage, a ROM, and a RAM), and a communicator.

### 1.3 Software Configuration

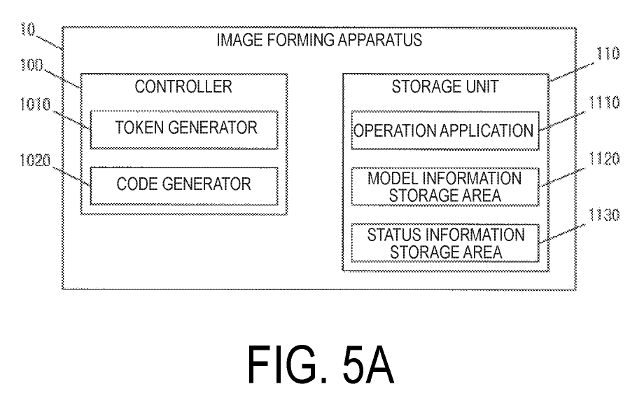

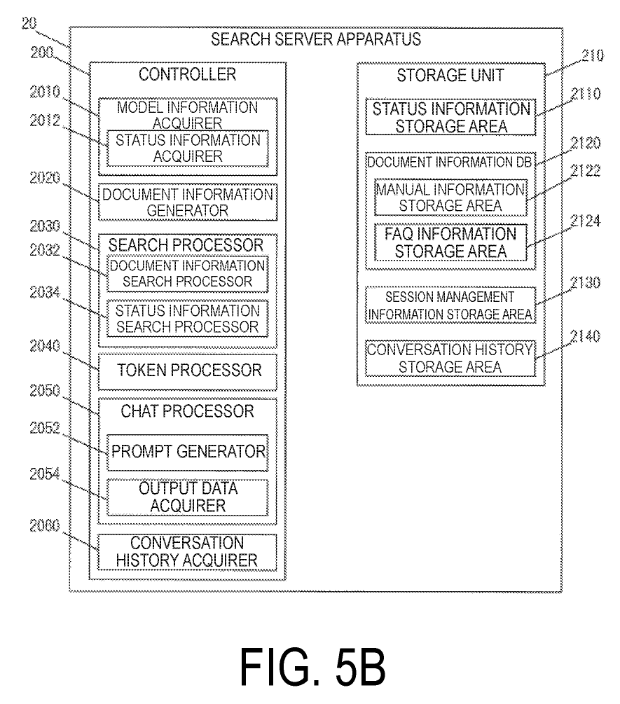

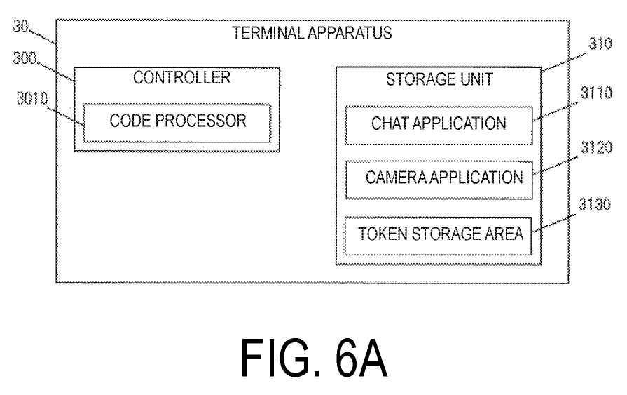

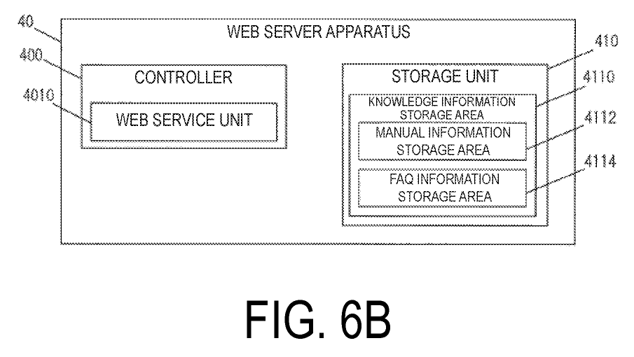

The main software configuration of each apparatus included in the system 1 will be described with reference to FIGS. 5A to 6B. The software configurations illustrated in FIGS. 5A to 6B mainly describe the configurations required in the embodiment, and other configurations are omitted.

### 1.3.1 Image Forming Apparatus

First, the main software configuration of the image forming apparatus 10 will be described with reference to FIG. 5A. For example, the controller 100 can implement a token generator 1010 and a code generator 1020 by reading and executing a program stored in the storage unit 110 (the storage 112 and the ROM 114).

The token generator 1010 generates a token for the terminal apparatus 30 to connect to the search server apparatus 20 and use the chat service provided by the system 1, for example.

The token generator 1010 may generate a token, for example, an access token including a device ID for the terminal apparatus 30 to establish a communication path with the search server apparatus 20 and connect, and connection information based on a session ID. The token generator 1010 may also encrypt the token. Furthermore, the token generator 1010 may output the generated token to, for example, the code generator 1020 or the short-range wireless communicator 180.

The code generator 1020 generates a code (for example, a two-dimensional code in the embodiment) using the token generated by the token generator 1010 as encoded information. Furthermore, the code generator 1020 may include, in the two-dimensional code, a connection destination (for example, a URL) of the search server apparatus 20 in addition to the token generated by the token generator 1010.

In the embodiment, the code generator 1020 generates a figure as a two-dimensional code, but instead of a figure, the code generator 1020 may also generate a character string (here, a character string is a character string of one or more characters. Furthermore, a character may include one or more numbers, English letters, kana, hiragana, kanji, symbols, etc.). Furthermore, the code generator 1020 may generate one-dimensional codes such as barcodes (for example, EAN codes, JAN codes, Cobabar, CODE128, etc.) in addition to two-dimensional codes. Furthermore, the two-dimensional code generated by the code generator 1020 may be a stack-type two-dimensional code (for example, PDF417, CODE49, etc.) or a matrix-type two-dimensional code (for example, a quick response code (QR Code (registered trademark)), DataMatrix, VeriCode, Aztec, etc.). In the following, in the embodiment, a quick response code (QR code) will be described as an example.

The storage unit 110 stores an operation application 1110. The operation application may be, for example, an application such as a user interface for allowing the user to operate the image forming apparatus 10.

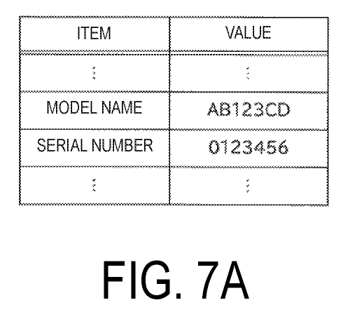

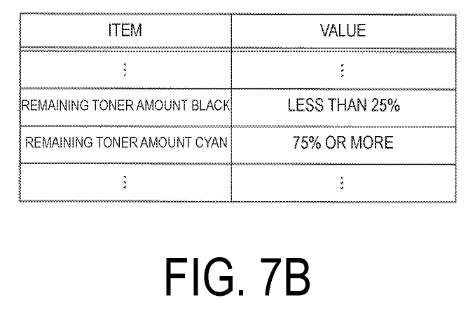

The storage unit 110 also secures a model information storage area 1120 for storing model information. The model information is information including identification information for identifying the image forming apparatus 10, such as a model name (model), a serial number (production number), and a firmware version of the image forming apparatus 10, for example. Here, an example of model information stored in the model information storage area 1120 will be described with reference to FIG. 7A. The model information stores an item (for example, a “model name”) and a value (for example, “AB123CD”).

Furthermore, the storage unit 110 secures a status information storage area 1130 for storing status information. The status information includes, for example, the status of the image forming apparatus 10, such as information on the remaining amount of toner, information on network settings, and information on events such as the occurrence of a paper jam. Here, an example of the status information stored in the status information storage area 1130 will be described with reference to FIG. 7B. The status information stores an item (for example, “remaining toner amount black”) and a value (for example, “less than 25%”).

### 1.3.2 Search Server Apparatus

Next, the main software configuration of the search server apparatus 20 will be described with reference to FIG. 5B. For example, the controller 200 can implement a model information acquirer 2010, a document information generator 2020, a search processor 2030, a token processor 2040, a chat processor 2050, and a conversation history acquirer 2060 by reading and executing a program stored in the storage unit 210 (the storage 212 and the ROM 214).

The model information acquirer 2010 acquires, for example, model information and information accompanying the model information from the image forming apparatus 10. Here, as information accompanying the model information, information such as status information as information indicating the state of the image forming apparatus 10 and configuration information as information indicating the configuration of the image forming apparatus 10 may be acquired. In the embodiment, a status information acquirer 2012 for acquiring status information may be further provided.

The status information acquirer 2012 acquires status information from the image forming apparatus 10 as information accompanying the model information. The status information acquirer 2012 stores the status information acquired from one or more image forming apparatuses 10 in the status information storage area 2110 for each of the plurality of image forming apparatuses 10. The status information will be described in detail later.

The status information acquirer 2012 may acquire the status information of the image forming apparatus 10 periodically, or may acquire the status information based on a request from the user. For example, the status information acquirer 2012 may store the status information acquired at predetermined time intervals in the status information storage area 2110. The status information acquirer 2012 may also store status information in the status information storage area 2110 by an interrupt that is executed based on the occurrence of an event (for example, running out of toner, paper jam, etc.).

The configuration information may include, for example, information about options and functions provided in the image forming apparatus 10. For example, the configuration information may include whether a staple function is provided, whether color printing is possible, whether a saddle stitch printing unit is provided, and the like.

The document information generator 2020 generates document information from knowledge information acquired from the web server apparatus 40, for example. Here, document information refers to knowledge information stored in a database as an internal database of the search server apparatus 20.

The document information generator 2020 generates document information by vectorizing the knowledge information acquired from the web server apparatus 40 using methods such as the k-nearest neighbor method, bag of words (BoW), term frequency-inverse document frequency (TF-IDF), and Word2vec. The document information generator 2020 stores the generated document information in a document information DB 2120.

The search processor 2030 searches for document information or status information based on the input sentence received from the terminal apparatus 30 and the model information of the image forming apparatus 10. In addition, in the embodiment, a document information search processor 2032 for searching for document information, and a status information search processor 2034 for searching for status information may be further provided.

When the result of category analysis of the input sentence received from the terminal apparatus 30 is a “question about an operation method for the apparatus,” the document information search processor 2032 compares the vectorized input sentence with the document information corresponding to the model information of the image forming apparatus 10 stored in the document information DB 2120 to search for candidates for an answer sentence. The document information search processor 2032 selects the specified document information as a candidate for an answer sentence corresponding to the user’s question.

When the result of category analysis of the input sentence received from the terminal apparatus 30 is a “question about the status of the apparatus,” the status information search processor 2034 compares the input sentence with the status information corresponding to the image forming apparatus 10 stored in the status information storage area 2110 to search for candidates for an answer sentence. The status information search processor 2034 selects the specified status information as a candidate for an answer sentence corresponding to the user’s question.

The search processor 2030 outputs the candidate for the answer sentence selected by the document information search processor 2032 and the status information search processor 2034 to the chat processor 2050.

The token processor 2040 reads the token acquired from the terminal apparatus 30 and executes a process of acquiring the connection information included in the token.

The chat processor 2050 executes a process for outputting an output sentence in the chat service. The chat processor 2050 executes a process that uses the large language model 52 to output an output sentence including an answer sentence.

In the embodiment, the chat processor 2050 may further include a prompt generator 2052 that generates a prompt to be output to the large language model 52, and an output data acquirer 2054 that acquires output data from the large language model 52.

Here, a prompt is information for instructing a language model (large language model 52). Moreover, output data refers to data output from the large language model 52 corresponding to a prompt, and includes, for example, answer sentences or category analysis results.

The chat processor 2050 may have the function of a message outputter that can, for example, output an answer sentence to an input sentence or output a message (notification sentence) as a notification to the user. The chat processor 2050 may acquire the message from, for example, a message storage area secured in the storage 212 and output the message.

The chat processor 2050 may also include, for example, a message generator capable of generating messages and outputting the generated messages. The message outputter may have a different configuration from the chat processor 2050.

The prompt generator 2052 generates prompts to be input to a language model (for example, the large language model 52) based on the input information. Here, the prompt generator 2052 can generate a prompt requesting a category analysis of the input sentence and a prompt requesting an answer sentence from the search results of the search processor 2030. The prompt may be in natural language format or in a predetermined format that uses tags or the like.

The prompt generator 2052 may generate, as a prompt requesting category analysis, a prompt including at least an input sentence, for example. The prompt generator 2052 may generate a prompt requesting category analysis, for example, including the type of question category and a condition for specifying the category, as necessary.

The prompt generator 2052 may generate, as a prompt for requesting an answer sentence, a prompt, for example, including the input sentence and document information and/or status information selected by a search of the search processor 2030.

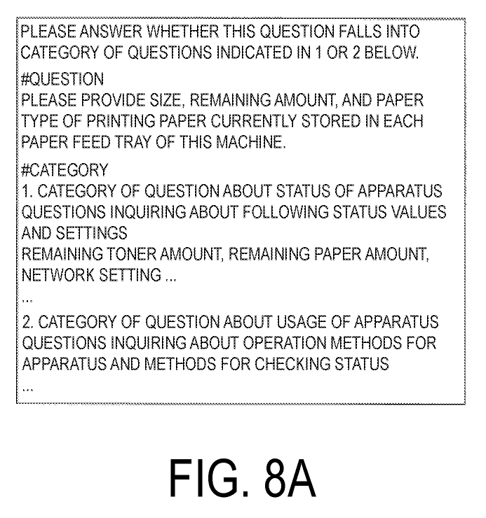

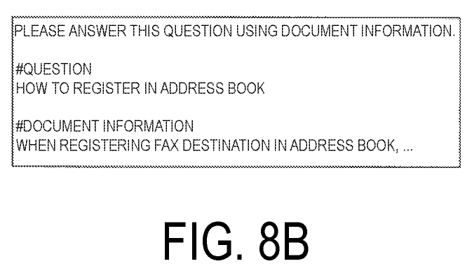

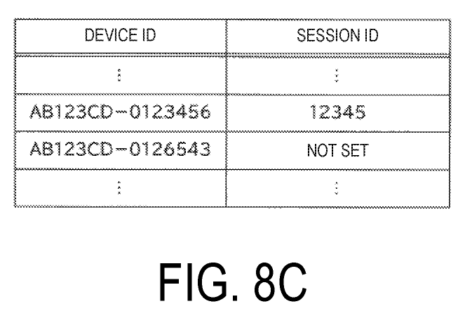

The prompt generator 2052 generates the prompts shown in FIGS. 8A and 8B, respectively. Here, the prompts shown in FIGS. 8A and 8B are schematically shown as natural languages.

The prompt shown in FIG. 8A is an example of a prompt that requests a category analysis of the input sentence from the large language model 52. The prompt in FIG. 8A includes the input sentence “Please provide the size, remaining amount, and paper type of the printing paper currently stored in each paper feed tray of this machine.”

Furthermore, the prompt in FIG. 8A includes a request for category analysis, such as “Please answer whether this question falls into the category of questions indicated in 1 or 2 below,” which further requests category analysis, the type of category to be analyzed, and the conditions for specifying the category.

The prompt shown in FIG. 8B is an example of a prompt that requests an answer sentence from the large language model 52. The prompt in FIG. 8B includes “How to register in an address book” as the input sentence, and “When registering a fax destination in the address book, ...” as the document information.

In this way, the prompt generator 2052 may generate a prompt by, for example, adding (embedding) necessary information into a template prepared in advance.

The prompt generator 2052 may optimize the input sentence or document information using the large language model 52 once, reconstruct it, or summarize it to generate a prompt.

The output data acquirer 2054 may include an answer acquirer that acquires an answer sentence from the output data received from the large language model 52 if the output data includes an answer sentence. Furthermore, the output data acquirer 2054 may include a category analysis result acquirer that acquires the category analysis result from the output data if the output data includes the analysis result of the category analysis of the input sentence.

The chat processor 2050 outputs the answer sentence acquired by the output data acquirer 2054 to the terminal apparatus 30. On the other hand, the chat processor 2050 may output, for example, the analysis result of the category analysis of the input sentence acquired by the output data acquirer 2054 to the search processor 2030.

The conversation history acquirer 2060 stores the conversation history in a conversation history storage area 2140 as conversation history information.

The storage unit 210 of the search server apparatus 20 secures the status information storage area 2110 for storing status information of the image forming apparatus 10. The status information storage area 2110 may store status information for each of the image forming apparatuses 10.

The storage unit 210 of the search server apparatus 20 secures the document information DB 2120 for storing document information. The document information DB 2120 further includes, for example, a manual information storage area 2122 that stores manual information for the image forming apparatus 10, and a FAQ information storage area 2124 that stores FAQ information related to the image forming apparatus 10.

The storage unit 210 of the search server apparatus 20 secures a session management information storage area 2130 for storing session management information. The session management information is information for managing a session in which the terminal apparatus 30 connects to the search server apparatus 20, for example. Here, an example of the session management information stored in the session management information storage area 2130 will be described with reference to FIG. 8C. The session management information stores a device ID (for example, “AB123CD-0123456”) and a session ID (for example, “12345”).

Here, the device ID is, for example, information that specifies the model of the device that receives questions from the user, and may include model information. Here, the session ID stores, for example, a value that does not overlap with other session IDs, or “not set” which means that no session corresponding to the corresponding device ID exists. The session management information storage area 2130 may further store information on the validity period of a session.

The storage unit 210 of the search server apparatus 20 secures the conversation history storage area 2140 for storing conversation histories.

### 1.3.3 Terminal Apparatus

Next, the main software configuration of the terminal apparatus 30 will be described with reference to FIG. 6A. For example, the controller 300 can implement a code processor 3010 by reading and executing a program stored in the storage unit 310 (the storage 312 and the ROM 314).

The code processor 3010 executes a process of, for example, decoding the code acquired by the imager 390, acquiring information including a token, and storing the information in a token storage area 3130.

The storage unit 310 also stores a chat application 3110 that provides a chat service, and a camera application 3120 that can operate the imager 390 to acquire an image. Furthermore, the storage unit 310 secures the token storage area 3130 for storing tokens.

The chat application 3110 may be, for example, an application that displays a chat screen on the display 340 and executes a chat function. Here, the chat screen refers to a display screen that serves as an interface for a chat service, allowing users to input questions and display messages.

In the embodiment, the terminal apparatus 30 stores the chat application 3110, but a chat service may be provided on a web browser instead of the chat application.

The camera application 3120 may be, for example, an application that executes an imaging function for capturing an image using the imager 390. In the embodiment, the camera application 3120 includes a function that can capture an image of a two-dimensional code and acquire information included in the captured two-dimensional code.

### 1.3.4 Web Server Apparatus

Furthermore, the main software configuration of the web server apparatus 40 will be described with reference to FIG. 6B. For example, the controller 400 can implement a web service unit 4010 by reading and executing a program stored in the storage unit 410 (the storage 412 and the ROM 414).

The web service unit 4010 can provide web services that support users via the network NW, for example. For example, the web service unit 4010 may transmit the knowledge information to the search server apparatus 20.

The storage unit 410 also secures a knowledge information storage area 4110 for storing knowledge information. The knowledge information storage area 4110 includes a manual storage area 4112 that stores manual information for the image forming apparatus 10 by model, and a FAQ information storage area 4114 that stores FAQ information for the image forming apparatus 10 by model.

### 1.4 Flow of Processing

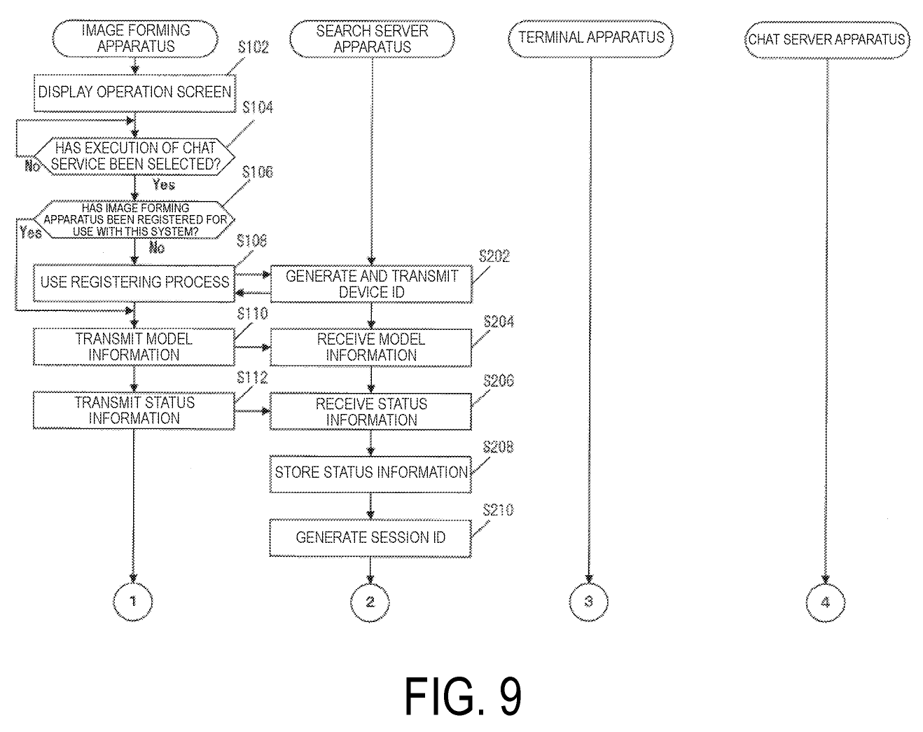

The flow of processing in the embodiment will be described below. FIGS. 9 to 13 are diagrams illustrating the flow of processing in the system 1 according to the embodiment.

The following processing will be described as being executed by the controllers (the controller 100, the controller 200, the controller 300) of the respective apparatuses (the image forming apparatus 10, the search server apparatus 20, and the terminal apparatus 30), but each component described in FIG. 5 or FIG. 6 may execute the processing of each step.

First, the controller 100 displays an operation screen on the display 140 of the image forming apparatus 10 (S102 in FIG. 9). Next, the controller 100 determines whether execution of the chat service has been selected (S104). For example, when a user operation such as pressing a help button or selecting to display a chat service is detected, the controller 100 may determine that execution of the chat service has been selected.

When it is determined that execution of the chat service has been selected, the controller 100 determines whether the image forming apparatus 10 has been registered for use with this system (S104; Yes → S106).

As a method for determining whether the image forming apparatus 10 has been registered for use, for example, when the image forming apparatus 10 determines that the execution of the chat service has been selected for the first time, and when the image forming apparatus 10 receives a device ID from the search server apparatus 20, the image forming apparatus 10 may determine that the image forming apparatus 10 has been registered for use.

On the other hand, the controller 100 waits until it determines that execution of the chat service has been selected (S104; No → S104).

Next, when the image forming apparatus has not been registered for use with this system, the controller 100 executes a use registering process (S106; No → S108).

In the use registering process, for example, first, the controller 100 transmits model information to the search server apparatus 20. Next, the controller 200 of the search server apparatus 20 generates a device ID based on the model information received from the image forming apparatus 10. Then, the controller 200 performs a series of processes, such as transmitting the device ID to the image forming apparatus 10 (S202).

Next, when the image forming apparatus 10 has been registered for use with this system (S106; Yes), or after the use registering process has been executed, the controller 100 transmits the model information to the search server apparatus 20 (S110).

Furthermore, the controller 100 transmits the status information of the image forming apparatus 10 stored in the status information storage area 1130 to the search server apparatus 20 (S112).

The controller 200 of the search server apparatus 20 receives the model information from the image forming apparatus 10 (S204). Furthermore, the controller 200 receives status information of the image forming apparatus 10 from the image forming apparatus 10 (S206), and stores the status information in the status information storage area 2110 (S208).

The controller 200 generates a session ID associated with the device ID from the model information received from the image forming apparatus 10 (S210). Here, the session ID is identification information for the session, and is used to create a session that is valid for a certain period of time each time a chat screen is displayed on the terminal apparatus 30, and to allow only the terminal apparatus 30 that has received the token to access the chat service. Next, the controller 200 transmits the generated session ID to the image forming apparatus 10 (S212).

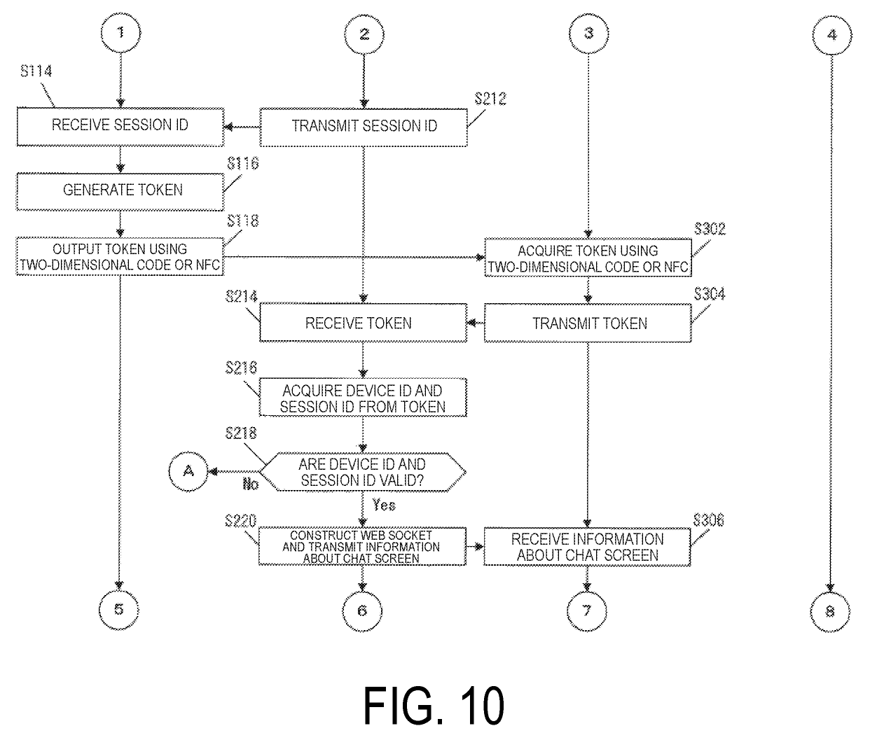

When the controller 100 of the image forming apparatus 10 receives the session ID from the search server apparatus 20 (S114 in FIG. 10), the controller 100 generates a token including the device ID and connection information based on the session ID (S116).

Next, the controller 100 outputs the generated token so that the terminal apparatus 30 can acquire the token (S118). For example, the controller 100 may display the generated token as a two-dimensional code (QR code). Alternatively, the controller 100 may turn on (enable) the short-range wireless communicator 180 and store the generated token in an NFC tag, for example.

The controller 300 of the terminal apparatus 30 acquires the token from the image forming apparatus 10 (S302). For example, when a two-dimensional code is displayed on the display 140 of the image forming apparatus 10, the controller 300 acquires the token included in the two-dimensional code by capturing an image of the code using the camera application 3120.

On the other hand, when the short-range wireless communicator 180 is enabled, the controller 300 performs short-range wireless communication to acquire the token by holding the short-range wireless communicator 380 of the terminal apparatus 30 over the device. Furthermore, the controller 300 may acquire connection destination information (for example, a connection destination URL of the search server apparatus 20) in addition to the token.

Next, the controller 300 connects to the search server apparatus 20 based on the connection destination information and transmits the token (S304).

The controller 200 of the search server apparatus 20 receives the token from the terminal apparatus 30 (S214). The controller 200 acquires the device ID and the session ID from the received token (S216). Here, for example, when the token is encrypted, the controller 200 may decrypt the token.

The controller 200 determines whether the device ID and the session ID acquired from the token are valid (S218).

The controller 200 may compare the device ID and session ID acquired from the terminal apparatus 30 with the session management information storage area 2130, and may determine the validity of the session ID, for example, based on the validity period of the session or the registration status of the device ID.

When the controller 200 determines that the device ID and the session ID are invalid, the controller 200 ends the process as it is (S218; No). Here, the controller 200 may transmit, for example, information about an error screen to the terminal apparatus 30 as a display screen that makes it impossible to input a question and ends the process.

On the other hand, when the controller 200 determines that the device ID and the session ID are valid, the controller 200 constructs a session and a web socket for the terminal apparatus 30 and transmits information about a chat screen to the terminal apparatus 30 (S218; Yes → S220).

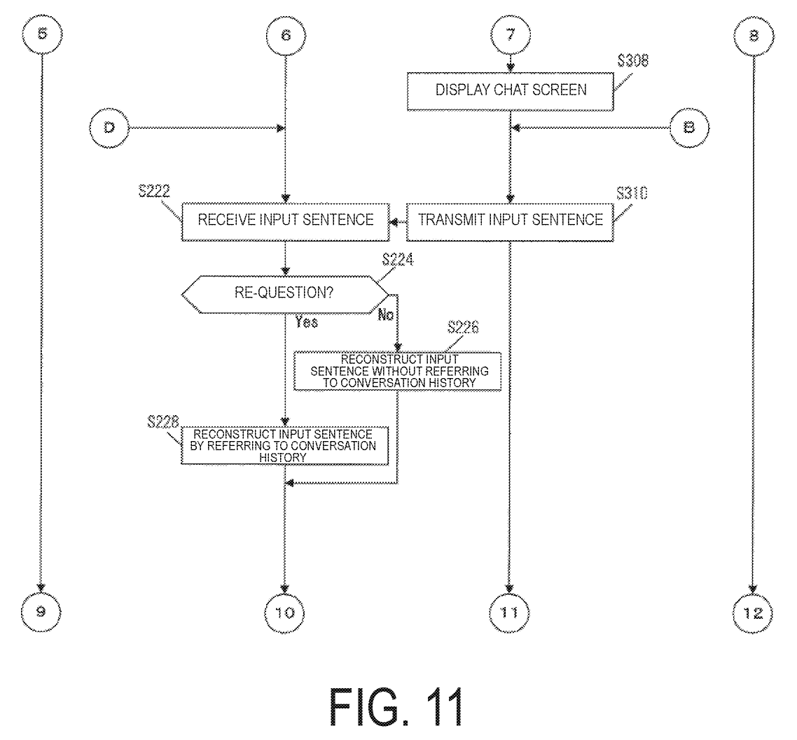

When the controller 300 of the terminal apparatus 30 receives the information about the chat screen from the search server apparatus 20 (S306), the controller 300 activates the chat application 3110, for example, and displays the chat screen on the display 340 (S308 in FIG. 11).

In the embodiment, the chat application 3110 is activated in S308, but when a token is acquired from the image forming apparatus 10, the chat application 3110 may be activated in the background and execute the processes from S302 onwards, for example.

Next, the controller 300 of the terminal apparatus 30 transmits an input sentence (question sentence) including a question input by the user on the chat screen to the search server apparatus 20 (S310).

When the controller 200 of the search server apparatus 20 receives an input sentence from the terminal apparatus 30 (S222), the controller 200 determines whether the received input sentence is a re-question (S224). As a method for determining whether the input sentence is a re-question, the controller 100 may determine that the input sentence is a re-question when, for example, a conversation history is stored or when a question transmission flag is ON.

When the input sentence is not a re-question, the controller 200 reconstructs the input sentence without referring to the conversation history (S224; No → S226). On the other hand, when the input sentence is a re-question, the controller 200 reconstructs the input sentence by referring to the conversation history stored in the conversation history storage area 2140 (S224; Yes → S228).

Here, reconstructing an input sentence means constructing the input sentence again by combining it with information for searching for candidates for a question. The controller 200 may reconstruct the input sentence by combining the model information, for example. Furthermore, when the controller 200 reconstructs an input sentence by referring to a conversation history, the controller 200 may reconstruct the input sentence by combining the conversation histories, for example.

The controller 200 may cause the large language model 52 to reconstruct the input sentence, or when the search server apparatus 20 stores a language model, the controller 200 may cause the language model stored in the search server apparatus 20 to reconstruct the input sentence.

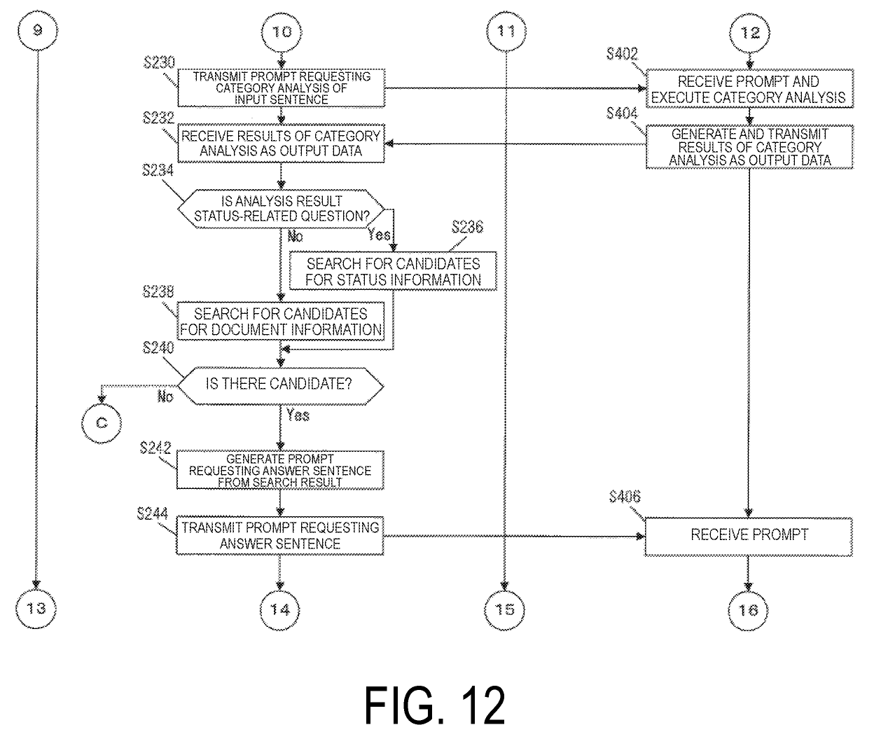

Next, the controller 200 generates a prompt requesting a category analysis of the reconstructed input sentence, and transmits the prompt to the large language model 52 of the chat server apparatus 50 (S230 in FIG. 12).

The large language model 52 of the chat server apparatus 50 receives the prompt from the search server apparatus 20. The large language model 52 executes a category analysis based on the prompt (S402). Here, the large language model 52 may execute a category analysis, for example, in the following manner.

(1) For example, if the input sentence includes status information and is a question inquiring about the status information, the analysis result of the category analysis may be the category of the question “question about the status of the apparatus.” For example, in response to an input sentence such as “How much is the remaining amount of printing toner?,” the large language model 52 may obtain a “question about the status of the apparatus” as the analysis result of the category analysis.

Furthermore, in response to an input sentence such as “Please provide the size, remaining amount, and paper type of the printing paper currently stored in each paper feed tray of this machine,” the large language model 52 may obtain a “question about the status of the apparatus” as the analysis result of the category analysis. In response to an input sentence such as “Please provide the network settings of this machine (IP address, subnet mask, default gateway, DNS server, domain name),” the large language model 52 may obtain a “question about the status of the apparatus” as the analysis result of the category analysis.

(2) For example, if the input sentence includes status information and is not a question inquiring about the status information, the analysis result of the category analysis may be a “question about the usage of the apparatus.” For example, in response to an input sentence such as “How do I check the remaining amount of printing toner?,” the large language model 52 may obtain a “question about the usage of the apparatus” as the analysis result of the category analysis.

(3) For example, if the input sentence is a question that does not include status information, the analysis result of the category analysis may be a “question about the usage of the apparatus.” For example, in response to an input sentence such as “How do I replace the toner cartridge?,” the large language model 52 may obtain a “question about the usage of the apparatus” as the analysis result of the category analysis.

(4) For example, if the input sentence is a question that includes words such as “method,” “usage,” or “how to do it,” which do not satisfy (1), instead of (3), the analysis result of the category analysis may be a “question about the usage of an apparatus.” For example, in response to an input sentence “Please provide the instructions on how to clear a paper jam,” the large language model 52 may obtain a “question about the usage of an apparatus” as the analysis result of the category analysis.

Next, the large language model 52 generates the analysis result of the category analysis of the input sentence as output data. The chat server apparatus 50 transmits the output data to the search server apparatus 20 (S404).

The controller 200 of the search server apparatus 20 receives the analysis result of the category analysis of the input sentence from the chat server apparatus 50 as output data (S232).

The controller 200 determines whether the analysis result received from the chat server apparatus 50 is a status-related question (S234). For example, when the analysis result of the category analysis of the input sentence is a “question about the status of the apparatus,” the controller 200 may determine that the input sentence is a status-related question.

When the controller 200 determines that the input sentence is a status-related question, the controller 200 searches the status information storage area 2110 for candidates for status information based on the reconstructed input sentence (S234; Yes → S236).

On the other hand, when the controller 200 determines that the input sentence is not a status-related question, the controller 200 searches the document information DB 2120 (internal database) for candidates for document information similar to the relevant model information based on the reconstructed input sentence (S234; No → S238).

For example, model information such as the model name is automatically acquired by the reconstruction in the reconstructed input sentence, and the controller 200 can thereby automatically filter the search range of candidates for document information. That is, in response to the question, the controller 200 can search an internal database relating to the usage of the apparatus based on the received model information, and extract one or more candidates for document information that corresponds to the model information.

Furthermore, the controller 200 performs similarity calculations for searches by vectorizing both the input sentence and document information in the same method, and selects document information by calculating the degree of approximation between the vectors.

As an example, it is assumed that when the user cannot think of keywords such as “pattern” or “watermark,” the user inputs an input sentence such as “When copied, the characters pop up.” Based on the vectorized search words included in the input sentence, such as “copy,” “characters,” and “pop up,” the controller 200 selects document information such as a “pattern” or “watermark” that is similar to the search words from a vectorized internal database.

In addition, when the controller 200 is unable to narrow down the document information to one, or when the user gives an answer to the first question that is not intended by the user, the controller 200 may narrow down the document information, for example, in the following manner.

For example, as a method of narrowing down the document information, the controller 200 may sort the document information in descending order of relevance as the search results of the candidate search and cause the user to select the top four documents as the next best answer. The controller 200 may transmit, to the terminal apparatus 30, a message indicating that there is another solution (another answer) and the selected document information. When an unintended answer is still output, the controller 200 may transmit, to the terminal apparatus 30, a message requesting that the wording be changed.

Next, the controller 200 determines whether there is a candidate for status information or document information in the search of S236 or S238 (S240).

Here, the controller 200 may determine that there is a candidate when there is at least one candidate for status information or document information, or when the reconstructed input sentence further includes model information.

When the controller 200 determines that the input sentence is not a status-related question and determines that there is a candidate for document information, the controller 200 generates a prompt as a search result, for example, requesting an answer sentence from the input sentence or document information (S238 → S240; Yes → S242).

When the controller 200 determines that the input sentence is a status-related question and determines that there is a candidate for status information, the controller 200 generates a prompt as a search result, for example, requesting an answer sentence from the input sentence or status information (S236 → S240; Yes → S242).

Then, the controller 200 transmits a prompt requesting the generated answer sentence to the large language model 52 of the chat server apparatus 50 (S244).

On the other hand, when there is no candidate for status information or document information corresponding to the input sentence, the process may be ended as it is (S240; No).

In addition, when the input sentence is not related to model information, such as when the input sentence does not include model information, the controller 200 may not output an answer sentence, or may generate and transmit to the terminal apparatus 30 a notification sentence indicating that an answer sentence will not be output in response to the input sentence. This allows the controller 200 to block inputs other than valid questions.

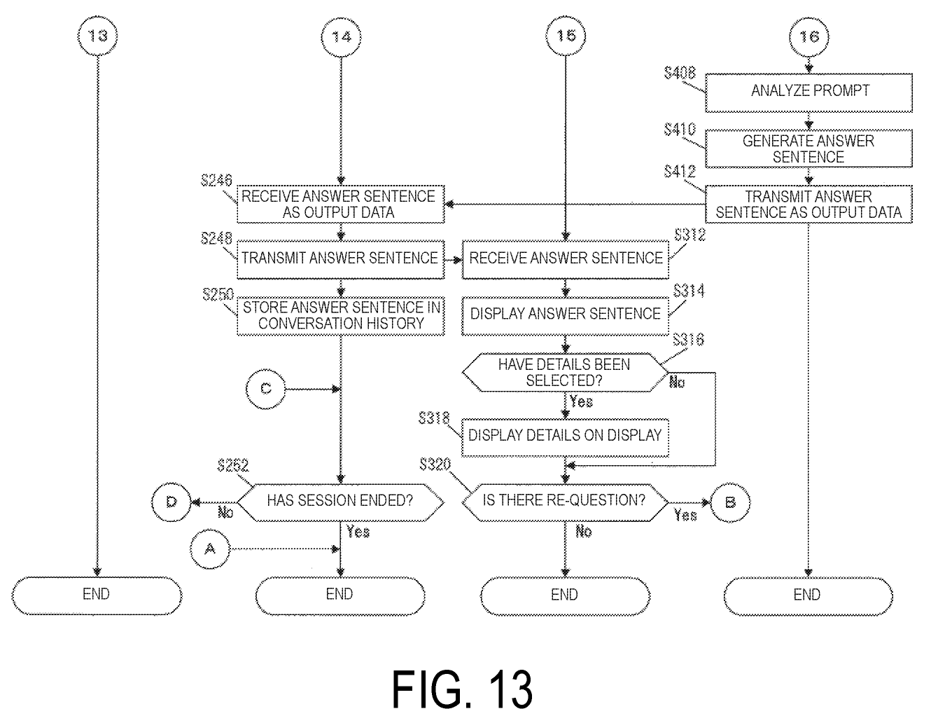

The chat server apparatus 50 receives a prompt requesting an answer sentence from the search server apparatus 20 (S406). Next, the large language model 52 of the chat server apparatus 50 analyzes the received prompt (S408 in FIG. 13).

Next, the large language model 52 of the chat server apparatus 50 generates an answer sentence based on the analyzed prompt (S410). The chat server apparatus 50 transmits the generated answer sentence to the search server apparatus 20 as output data (S412).

The controller 200 of the search server apparatus 20 receives the answer sentence as output data from the chat server apparatus 50 (S246). Next, the controller 200 transmits the received answer sentence to the terminal apparatus 30 (S248).

When the controller 300 of the terminal apparatus 30 receives the answer sentence from the search server apparatus 20 (S312), the controller 300 displays the answer sentence on the display 340 (S314). Here, when the detailed information included in the answer sentence includes a connection destination for manual information or FAQ information (for example, a URL to detailed information on the web server apparatus 40), the controller 300 will also display a link on the display 340 that can display the details.

Next, the controller 300 determines whether the details included in the answer sentence have been selected (S316). Here, as a method for determining whether details have been selected, the controller 300 may determine that details have been selected when the user selects (for example, clicks or touches) a connection destination such as a URL to detailed information. When the controller 300 determines that the details included in the answer sentence have been selected, the controller 300 connects to the web server apparatus 40 and displays the details on the display 340 (S316; Yes → S318), for example.

Then, the controller 300 determines whether there is a re-question, for example, whether an input sentence has been input again (S318 → S320). On the other hand, when “Details” is not selected, the controller 300 determines whether there is a re-question, for example, whether an input sentence has been input again (S316; No → S320).

When the controller 300 determines that there is a re-question, for example, that an input sentence has been input again, the controller 300 transmits the input sentence again to the search server apparatus 20 (S320; Yes → S310). When there is no re-question, for example, when there is no further input of an input sentence, the session ends and the process ends (S320; No).

On the other hand, after transmitting the answer sentence in S248, the controller 200 of the search server apparatus 20 stores the answer sentence transmitted in S248 as a conversation history in the conversation history storage area 2140 (S250). Next, the controller 200 determines whether the session has ended (S252).

As a method for determining whether a session has ended, for example, the session may be determined to have ended when there is no input sentence from the terminal apparatus 30 for a certain period of time, or when a notification to end the session is transmitted from the terminal apparatus 30.

When the controller 200 determines that the session has not ended, the controller 200 receives an input sentence again from the terminal apparatus 30 (S252; No → S222). On the other hand, when the controller 200 determines that the session has ended, the controller 200 ends the process (S252; Yes).

The above-described operation flow is an example, and some processing may be performed differently. For example, in the processes of S402 and S404, the large language model 52 may output the analysis result of the category analysis “question about apparatus status and usage” that satisfies (4) and (1). Next, in the case of the analysis result of the category analysis of “question about apparatus status and usage,” the controller 200 may execute steps S236 and S238, respectively, to generate an answer sentence.

Accordingly, in response to an input sentence such as “Please provide the instructions on how to clear the paper jam at the location where the paper jam is currently occurring in this machine,” the controller 200 can generate an answer sentence such as, for example, “The paper jam is in the manual feed tray. To clear the paper jam...”

### 1.5 Operation Example

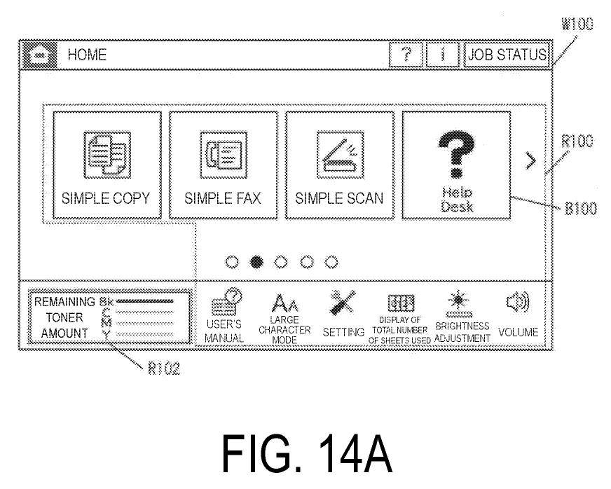

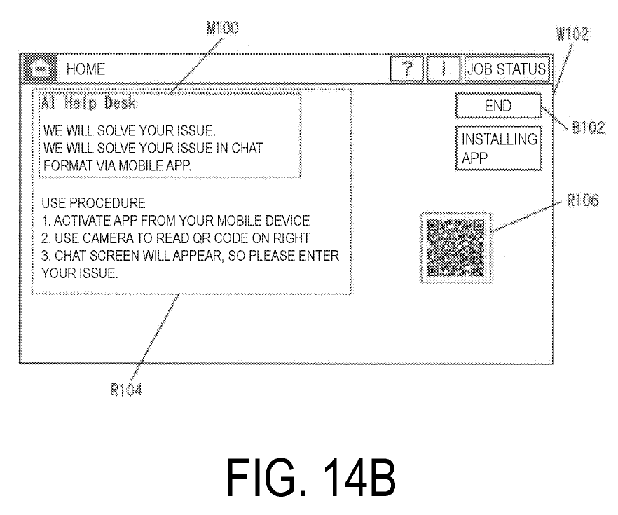

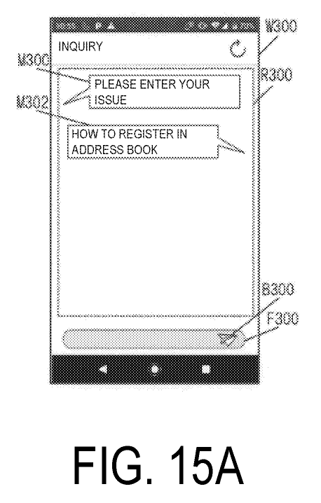

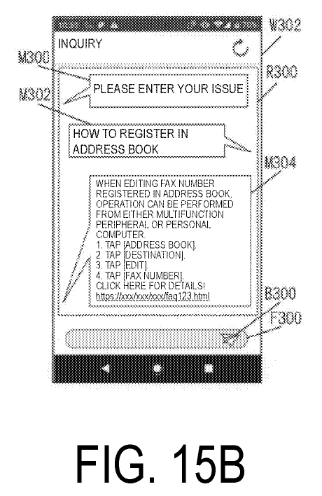

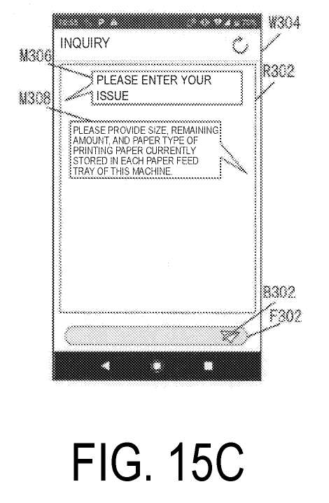

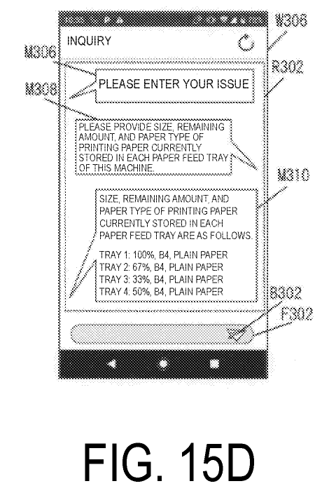

FIGS. 14A, 14B, and 15A to 15D are diagrams showing examples of display screens including messages displayed to the user as a result of the operations of the image forming apparatus 10 and the terminal apparatus 30 in the embodiment.

FIG. 14A is a diagram showing an example of a display screen W100 displayed on the display 140 of the image forming apparatus 10. In the display screen W100, a function display area R100 for displaying various function icons and a display area R102 for displaying status such as the remaining toner amount are secured. In the display area R100, a display button B100 is displayed as a help button for selecting execution of a chat service.

FIG. 14B is a diagram showing an example of a display screen W102 that is displayed on the display 140 of the image forming apparatus 10 when the user selects the display button B100 on the display screen W100. In the display screen W102, a display area R104 for displaying the use procedure for starting a chat service using a two-dimensional code, and a display area R106 for displaying the two-dimensional code are secured.

In the display area R104, a message M100 “AI Help Desk: We will solve your issue. We will solve your issue in a chat format via the mobile app” is displayed. Also, on the display screen W102, a display button B102 for ending the process and displaying the display screen W100 is displayed.

Here, when a user reads the two-dimensional code displayed in the display area R106, for example, using the camera application 3120 of the terminal apparatus 30, the controller 300 activates the chat application 3110 and displays the chat screen on the display 340 of the terminal apparatus 30.

In the embodiment, a two-dimensional code is displayed on the display 140, and the display screen for starting the chat service is displayed by reading the two-dimensional code with the terminal apparatus 30, but the chat service may also be started using the short-range wireless communicator 180.

FIG. 15A is a diagram showing an example of a display screen W300 that is displayed on the display 340 of the terminal apparatus 30 as a chat screen when the terminal apparatus 30 starts using a chat service using a two-dimensional code or the short-range wireless communicator 180.

In the display screen W300, a display area R300 for displaying messages in a conversational format in chronological order is secured, an input form F300 for inputting an input sentence as a question and a send button B300 for transmitting the input sentence entered in the input form F300 are displayed. In the display area R300, a message M300 “Please enter your issue” to prompt the user to input an input sentence and a message M302 “How to register in the address book” as an input sentence in the category of question about the usage of the apparatus are displayed.

FIG. 15B is a diagram showing an example of a display screen W302 that is displayed on the display 340 of the terminal apparatus 30 when the user inputs the message M302 as an input sentence for a question about the operation on the display screen W300.

On the display screen W302, the display area R300 is secured, and the input form F300 and the send button B300 are displayed therein. Furthermore, the message M300 and the message M302 are displayed on a timeline in the display area R300 of the display screen W302.

Furthermore, the display area R300 displays the answer to message M302: “When editing the fax number registered in the address book, the operation can be performed from either the multifunction peripheral or the personal computer. 1. Tap [Address Book]. 2. Tap [Destination]. 3. Tap [Edit]. 4. Tap [Fax Number]. Click here for details! A message M304 “https: //xxx/xxx/xxx/xxx/ faq123.html” is displayed on the timeline. Here, the message M304 displays an answer sentence including document information corresponding to the category of the question about the operation.

In this way, in the case of an input sentence for a category of question about the usage of an apparatus, such as “how to register in an address book,” an answer sentence for the category of question about the usage of an apparatus can be obtained.

The terminal apparatus 30 also displays an answer corresponding to the model of the MFP in the message M304. Furthermore, the terminal apparatus 30 may display a link in the message M304 that allows the details of the answer to be displayed. When the user selects a displayed link, the terminal apparatus 30 may display detailed information of the link destination on the display 340.

Here, the detailed information is the manual information and FAQ information that are the basis for the answer sentence of message M304 and that are posted on the manufacturer’s public website (homepage). The terminal apparatus 30 may refer to the URL of the web page on which the detailed information is posted and display it in, for example, a web browser.

FIG. 15C is a diagram showing an example of a display screen W304 that is displayed as a chat screen on the display 340 of the terminal apparatus 30 when use of the chat service is started, similarly to the display screen W300.

In the display screen W304, a display area R302 for displaying messages in a conversational format in chronological order is secured, an input form F302 for inputting an input sentence as a question and a send button B302 for transmitting the input sentence entered in the input form F302 are displayed. In the display area R302, a message M306 “Please enter your issue” to prompt the user to input an input sentence is displayed. Furthermore, in the display area R302, a message M308 “Please provide the size, remaining amount, and paper type of the printing paper currently stored in each paper feed tray of this machine” as an input sentence in the category of question about the status of the apparatus is displayed.

FIG. 15D is a diagram showing an example of a display screen W306 that is displayed on the display 340 of the terminal apparatus 30 when the user inputs the message M308 as an input sentence for a question about the status on the display screen W304.

On the display screen W306, the display area R302 is secured, and the input form F302 and the send button B302 are displayed therein. Furthermore, the message M306 and the message M308 are displayed in the display area R302 of the display screen W306.

Furthermore, in the display area R302, a timeline is displayed with a message M310, which is the answer to the message M308: “The size, remaining amount, and paper type of printing paper currently stored in each paper feed tray are as follows: Tray 1: 100%, B4, plain paper Tray 2: 67%, B4, plain paper Tray 3: 33%, B4, plain paper Tray 4: 50%, B4, plain paper.” Here, the message M310 displays an answer sentence including status information corresponding to the category of the question about the status.

In this way, the user can obtain an answer sentence that includes the status information desired by the user, rather than an answer sentence that corresponds to the category of question about the usage of the apparatus, such as “The size of the printing paper currently stored can be checked via the operation panel of the multifunction peripheral...” as shown in the example of a known answer sentence in FIG. 2.

Similarly, in response to a user’s input sentence of “Please provide the network settings of this machine,” an answer sentence including status information such as “The network settings of this machine are as follows...” is displayed on the display 340.

In this case too, the user can obtain an answer sentence that includes the status information that corresponds to the category of question about status, rather than an answer sentence that corresponds to the category of question about the usage of the apparatus, such as “To check the network settings of the multifunction peripheral, you can access them via the operation panel...”

When the user inputs a question such as “How do I replace the toner cartridge?,” an answer sentence corresponding to the category of question about the usage of the apparatus desired by the user, such as “To replace the toner cartridge...,” is displayed on display 340.

In this way, in the embodiment, by analyzing the category of the question, the system 1 is able to output not only answer sentences about the unique usage of each model, but also answer sentences about the unique state of each individual model. This makes it possible to display to the user an appropriate answer sentence that the user desires.

### 1.6 Effects, etc.

It is possible to output an appropriate answer that is in accordance with the content of the user’s question included in the input sentence and that the user desires.

When the user selects the help button, the image forming apparatus 10 transmits status information to the search server apparatus 20, and the search server apparatus 20 stores the received status information in the status information storage area 2110. The search server apparatus 20 receives an input sentence that a user has input as a question to a chat application from the terminal apparatus 30, and makes a request to, for example, the large language model 52 to perform a category analysis of the received input sentence.

Here, when the input sentence is a question related to status, the search server apparatus 20 can search for candidates from the status information stored in the status information storage area 2110 and generate a prompt. On the other hand, when the question is not related to the status and is not about the status, a prompt is generated by searching for candidates from the document information. The search server apparatus 20 can then transmit a prompt to a language model such as the large language model 52 and display the resulting answer sentence on the chat screen of the terminal apparatus 30.

In other words, it is possible to output not only answer sentences regarding the operation and usage of the image forming apparatus 10 but also answer sentences regarding the status of the image forming apparatus 10, and therefore an appropriate answer can be given depending on the content of the question input by the user.

### 2. Second Embodiment

A second embodiment will be described below. The second embodiment is an embodiment in which, a case where there is an abnormality in the status information when the chat service is started, a message (notification sentence) notifying the abnormality is displayed.

In the second embodiment, the same hardware and software configurations as those of the first embodiment will not be described, and differences from the first embodiment will be mainly described.

### 2.1 Flow of Processing

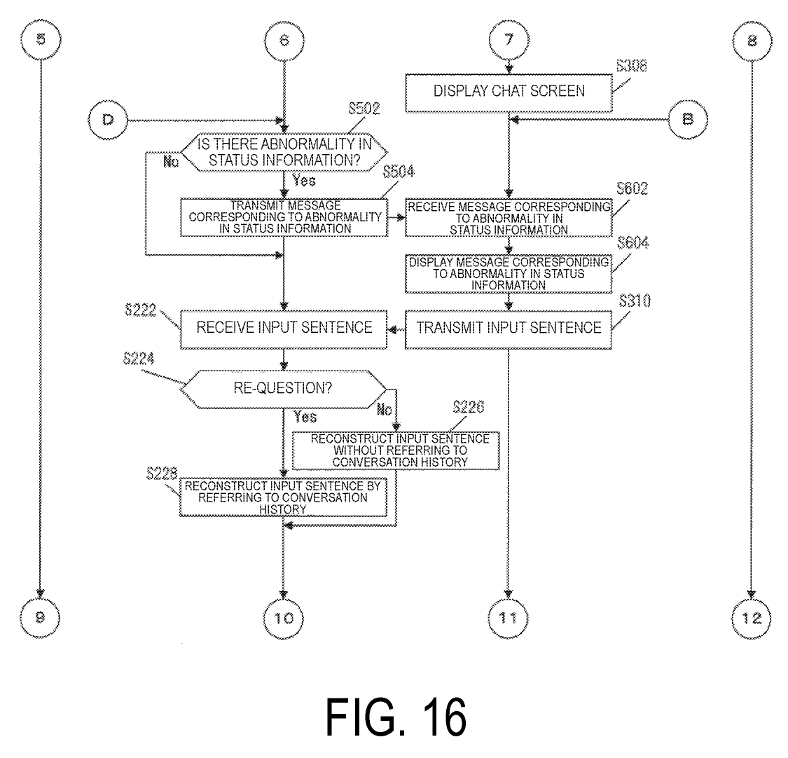

The flow of processing in the embodiment will be described below with reference to FIG. 16. FIG. 16 is a replacement for FIG. 11 of the first embodiment, and S502 and S504 are executed before S222, and S602 and S604 are executed between S308 and S310.

After transmitting the information on the chat screen to the terminal apparatus 30, the controller 200 determines whether there is an abnormality in the status information (S220 → S502).

Here, as a method for determining whether there is an abnormality in the status information, the controller 200 may refer to the status information in the status information storage area 2110 and predefined specific status information and, when they match, determine that there is an abnormality in the status information.

Here, predefined specific status information refers to information in which specific values are defined for the status information items, such as “ON” being defined as the value for the paper jam event item, or “25% or less” being defined as the value for the remaining toner amount item.

In the embodiment, it is determined that there is an abnormality in the status information when it matches predefined specific status information, but a threshold value may be defined, and for example, when the value of the specific status information exceeds the threshold value, the controller 200 may determine that there is an abnormality in the status information.

Furthermore, there may be, for example, a plurality of pieces of predefined specific status information to be referenced. That is, when the items and values of the status information in the status information storage area 2110 satisfy a specific condition, the controller 200 may determine that there is an abnormality in the status information.

When the controller 200 determines that there is an abnormality in the status information, the controller 200 transmits a message corresponding to the abnormality in the status information to the terminal apparatus 30 (S502; Yes → S504). The message corresponding to the abnormality in the status information may be a notification sentence.

The controller 200 may generate and transmit a message corresponding to an abnormality in the status information, for example, using the large language model 52 or a language model stored in the search server apparatus 20, or may generate and transmit the message from one stored in the storage unit 210. Furthermore, the controller 200 may store a message corresponding to the abnormality in the status information as a conversation history after transmitting the message in S504, for example.

On the other hand, when it is determined that there is no abnormality in the status information, an input sentence from the user is received from the chat screen of the terminal apparatus 30 (S502; No → S222).

When the controller 300 of the terminal apparatus 30 receives, from the search server apparatus 20, a message corresponding to an abnormality in the status information, the controller 300 displays the message on the display 340 (S602 → S604).

Here, the message corresponding to the abnormality in the status information may be a message including a suggestion to prompt the user to check and take action regarding the abnormality in the status information, and may be displayed as a counter-question message.

Specifically, when the remaining amount of toner is low, a message prompting the user to check the remaining amount of toner may be displayed, such as “Would you like to check the remaining amount of toner?” or when a paper jam occurs, a message prompting the user to take action may be displayed, such as “It appears there is a paper jam. Would you like to find out how to resolve it?.”

Furthermore, in the embodiment, a message corresponding to an abnormality in the status information is output before the input sentence is received, but a message corresponding to an abnormality in the status information may be output after the input sentence is received. For example, a message corresponding to the abnormality in the status information may be output after the processing of S248.

### 2.2 Operation Example

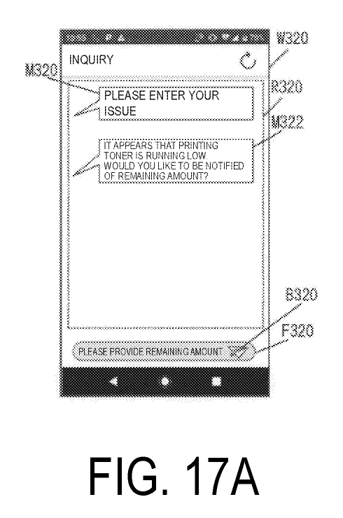

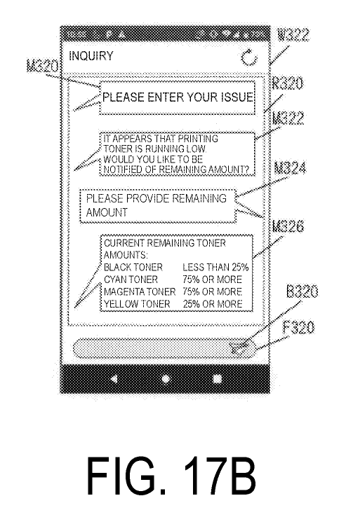

FIGS. 17A and 17B are diagrams showing examples of display screens including messages displayed to the user as a result of the operation of the terminal apparatus 30 in the embodiment. FIG. 17A is a diagram showing an example of a display screen W320 that is displayed on the display 340 of the terminal apparatus 30 as a chat screen when the terminal apparatus 30 starts using a chat service in the same manner as the display screen W300 and it is determined that there is an abnormality in the status information.

In the display screen W320, a display area R320 for displaying messages in a conversational format in chronological order is secured, an input form F320 for inputting an input sentence as a question and a send button B320 for transmitting the input sentence entered in the input form F320 are displayed.

In the display area R320, a message M320 “Please enter your issue” to prompt the user to input an input sentence, and a message M322 “It appears that the printing toner is running low. Would you like to be notified of the remaining amount?” are displayed. Here, the message M322 is a message that notifies the user of an abnormality in the status information, and includes, for example, a counter-question from the system 1 that prompts the user to check and take action.

FIG. 17B is a diagram showing an example of a display screen W322 that is displayed on the display 340 of the terminal apparatus 30 when the user inputs an input sentence including a question in response to a counter-question from the system 1 on the display screen W320.

On the display screen W322, the display area R320 is secured, and the input form F320 and the send button B320 are displayed therein. Furthermore, the message M320, the message M322, a message M324, and a message M326 are displayed in the display area R320 of the display screen W322.

Here, the message M324 is an input sentence including the user’s question “Please provide the remaining amount” in response to the message M322. Furthermore, the message M326 displays an answer sentence to the message M324 including status information such as “Current remaining toner amounts: Black toner less than 25%, Cyan toner 75% or more, Magenta toner 75% or more, Yellow toner 25% or more.”

### 2.3 Effects, etc.

In this way, when there is an abnormality in the status information of the image forming apparatus 10, a message including a counter-question for suggesting to prompt the user to check and take action can be displayed. The user can immediately check and deal with any abnormalities in the status information of the image forming apparatus 10 on the spot by using the chat service.

That is, when there is an abnormality in the status information of the image forming apparatus 10, the user does not need to refer to a manual or FAQ, for example, but can check and take action with a simple operation.

### 3. Third Embodiment

A third embodiment will be described below. The third embodiment is an embodiment that can output an answer sentence without using the large language model 52 when the content of the input sentence is a question related to status.

In the third embodiment, the description of the same hardware and software configurations as those in the first embodiment will be omitted, and the description will focus on the differences from the first embodiment.

### 3.1 Flow of Processing

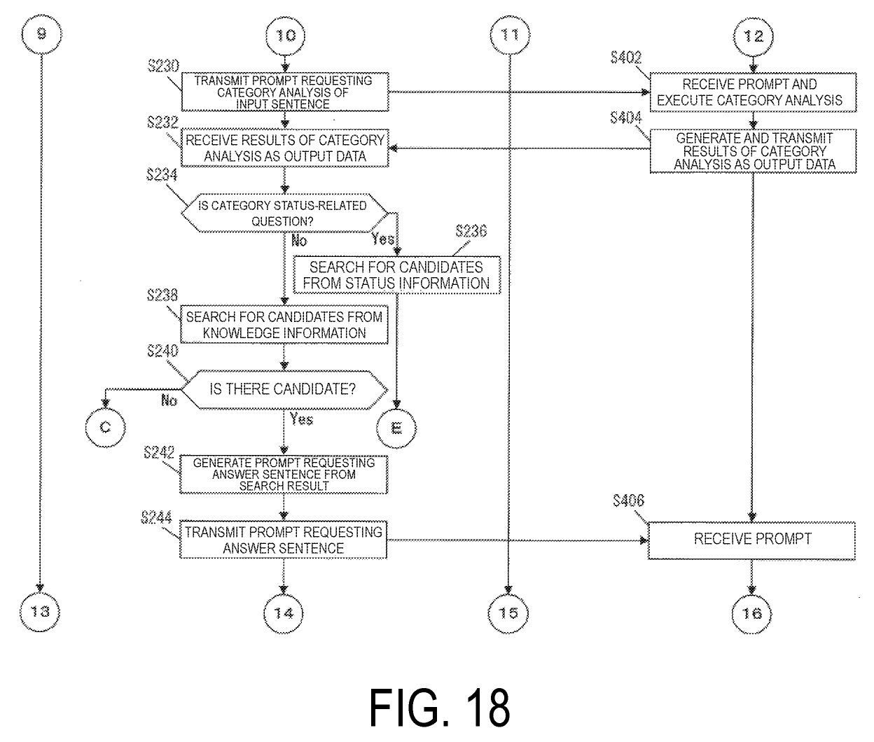

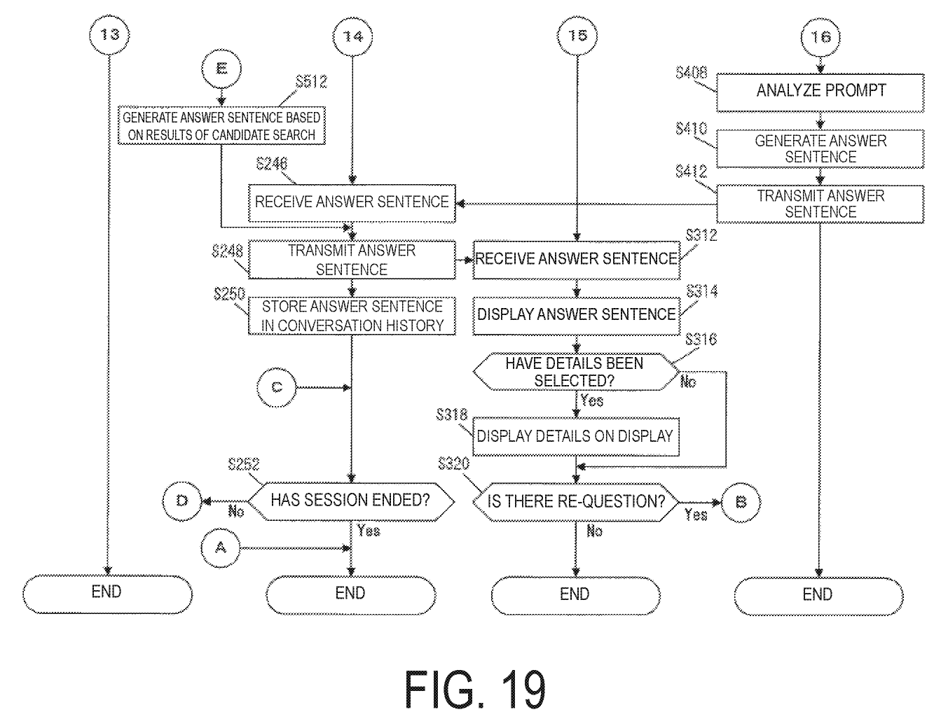

The flow of processing in the embodiment will be described below. FIGS. 18 and 19 are diagrams illustrating the flow of processing in the system 1 according to the embodiment. FIGS. 18 and 19 are replacements for FIGS. 12 and 13 of the first embodiment, and S512 is executed after S236.

The controller 200 searches for candidates for status information from the status information storage area 2110, generates an answer sentence based on the results of the candidate search, and transmits the generated answer sentence to the terminal apparatus 30 (S236 in FIG. 18 → S512 in FIG. 19 → S248).

Here, the search server apparatus 20 may generate the answer sentence by, for example, acquiring data from an SQL query, by using a template engine, or by using a language model stored in the search server apparatus 20.

### 3.2 Operation Example

The search server apparatus 20 can generate an answer sentence regarding the status information without using the large language model 52 of the chat server apparatus 50. Since the search server apparatus 20 does not need to transmit a prompt to the chat server apparatus 50, the answer sentence can be output more quickly.

### 4. Fourth Embodiment

A fourth embodiment will be described below. The fourth embodiment is an embodiment that can output an answer sentence including a status display method when the input sentence is an inquiry about the status of an information processing apparatus that is not included in the status information of the information processing apparatus.

In the fourth embodiment, the same hardware and software configurations as those of the first embodiment will not be described, and differences from the first embodiment will be mainly described.

### 4.1 Software Configuration

The main software configuration of each apparatus included in the system 1 will be described.

The status information acquirer 2012 may limit the status information to be transmitted, taking into consideration security, privacy, administrator authority, authority of other users, and the like among the status information of the image forming apparatus 10.

In the embodiment, the status information acquirer 2012 acquires limited status information, but the image forming apparatus 10 may also transmit limited status information taking into consideration security, privacy, administrator authority, the authority of other users, and the like.

As an example, the status information acquirer 2012 may not acquire information such as passwords or user names registered in the image forming apparatus 10, or may limit the status information that can be acquired due to capacity constraints.

The status information acquirer 2012 may store a value such as “invalid” in the status information storage area 2110 for status information that could not be acquired.

### 4.2 Flow of Processing

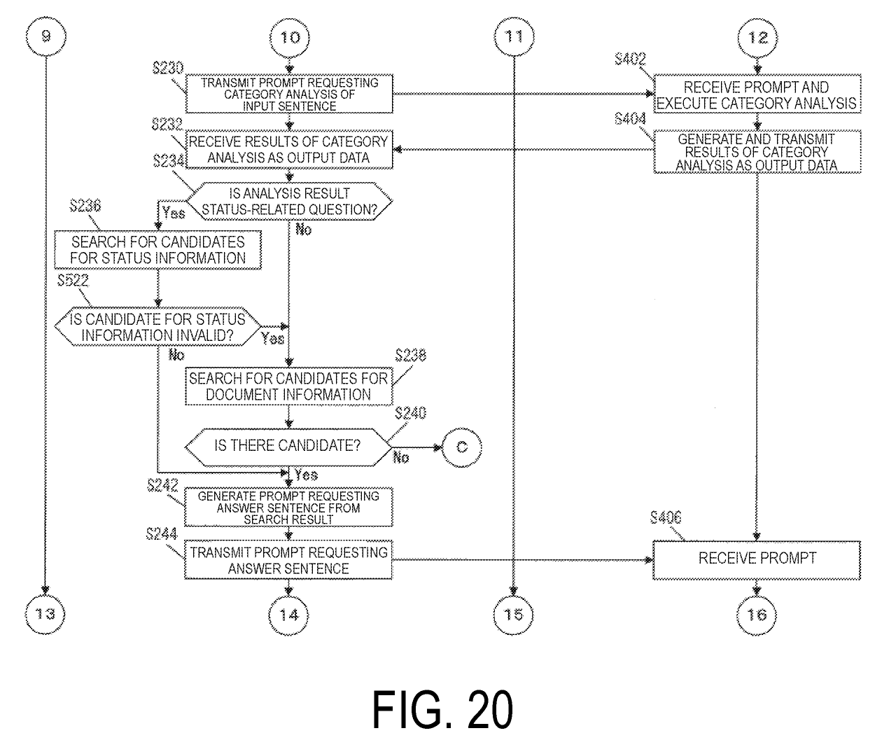

The flow of processing in the embodiment will be described below. FIG. 20 is a diagram illustrating the flow of processing in the system 1 according to the embodiment. FIG. 20 is a replacement for FIG. 12 of the first embodiment, and S522 is executed after S236.

The controller 200 searches for candidates for status information from the status information storage area 2110, and determines whether the status information of the searched candidates is “invalid” (S236 → S522).

Here, the controller 200 may determine that the status information is “invalid” when the value of the status information of the searched candidate is “invalid” or when no candidate for the status information of the searched candidate is found.

When the controller 200 determines that the status information is “invalid,” the controller 200 searches for candidates for document information for the invalid status information (S522; Yes → S238). On the other hand, when the controller 200 determines that the status information is not invalid, the controller 200 generates a prompt requesting an answer sentence from the search results (S522; No → S242).

### 4.3 Operation Example

The controller 200 determines whether the status information is invalid based on capacity constraints, security and privacy issues, administrator authority, or the authority of other users. The controller 200 can generate a prompt requesting an answer sentence including a status display method based on the determination.

Accordingly, when the system 1 has not sent all of the status information of the image forming apparatus 10 to the search server apparatus 20, instead of displaying the status information, the system 1 can display a method for displaying the status information on the terminal apparatus 30.

That is, when the system 1 cannot output an answer sentence corresponding to the category of “question about status,” the system 1 can change the category to a different one, such as “question about the usage of the apparatus.”

In the embodiment, the case where there are two categories has been exemplified, but in the case where there are three or more categories, the controller 200 may generate a prompt requesting category analysis again. In this case, the system 1 can select the next best category.

### 4.4 Effects, etc.

According to the embodiment, the system 1 is able to change the prompts generated by the search server apparatus 20 or the display output by the terminal apparatus 30 by causing the search server apparatus 20 to determine security, privacy, administrator authority, the authority of other users, and the like.

### 5. Modification Example

The disclosure is not limited to the embodiments described above and can be modified in various ways.

In other words, embodiments obtained by combining technical mechanisms appropriately changed without departing from the gist of the disclosure are also included in the technical scope.

Although the above-described embodiments have been separately described for convenience of description, the embodiments can be combined and executed within an allowable range. The right of any of the technologies described herein is intended to be acquired through amendment, divisional application, or the like.

The programs running on each apparatus in the embodiments are programs for controlling a CPU or the like (programs for causing a computer to function) to implement the aforementioned functions in the embodiments. Information handled by these apparatuses is temporarily accumulated in a transitory storage apparatus (for example, a RAM) at the time of processing, is then stored in a storage apparatus such as any of various ROMs or an HDD, and is read, corrected, and written by the CPU as needed.

The recording medium storing the programs may be any of a semiconductor medium (for example, a ROM, a non-volatile memory card, or the like), an optical recording medium or a magneto-optical recording medium (for example, a Digital Versatile Disc (DVD), a Compact Disc (CD), a Blu-ray (registered trademark) Disc (BD) or the like), a magnetic recording medium (for example, a magnetic tape, a flexible disk, or the like), and the like.

When the programs are distributed to market, the programs can be stored and distributed in a portable recording medium, or can be transferred to a server computer connected via a network such as the Internet. In this case, it is a matter of course that the storage apparatus of the server apparatus is also included in the disclosure.

Instead of being stored in the apparatus, the above-described data may be stored in an external apparatus and called as appropriate. For example, the data may be stored in a network attached storage (NAS) or may be stored on a cloud.

It should be noted that the scope of the disclosure is not limited to the configurations explicitly described herein, and a combination of technologies disclosed herein is also included in the scope thereof. Configurations of the disclosure sought to be patented are set forth in the appended claims, but configurations not recited in the claims are not intended to be excluded from the technical scope.

In the above-described specification, the descriptions “in a case in which ...” and “when ...” are described as examples, and the configuration is not limited to the described contents. Configurations not indicated by the descriptions “in a case in which ...” and “when ...” are also disclosed to the extent that the configurations are obvious to those skilled in the art, and the rights thereof are intended to be acquired.

The processing and the flow of data have been described herein in order, but the order thereof is not limited to the described order. For example, a configuration in which processing is partly removed or the order is rearranged is also disclosed, and the right thereof is intended to be acquired.

Although the functions described in the embodiments are described as being performed in the respective apparatuses, the functions may be implemented in one apparatus or using an external server.

In addition, each functional block or various features of the apparatus used in the above-described embodiments may be implemented or executed by an electric circuit such as, for example, an integrated circuit or a plurality of integrated circuits. An electric circuit designed to perform the functions described in the present specification may include a general-purpose processor, a digital signal processor (DSP), an application specific integrated circuit (ASIC), a field programmable gate array (FPGA) or other programmable logic apparatus, discrete gate or transistor logic, discrete hardware components, or a combination thereof. The general-purpose processor may be a microprocessor or may be a known processor, controller, microcontroller, or state machine. The electric circuit described above may include a digital circuit or an analog circuit. Further, when an integrated circuit technology for replacement into a current integrated circuit emerges with the development of semiconductor technology, a new integrated circuit based on the technology may also be used in one or more modes of the disclosure.

While there have been described what are at present considered to be certain embodiments of the invention, it will be understood that various modifications may be made thereto, and it is intended that the appended claim cover all such modifications as fall within the true spirit and scope of the invention.

What is claimed is:

1. A system comprising:
a status information acquirer that acquires status information of an information processing apparatus;
a receiver that receives an input sentence;
an answer acquirer that acquires an answer sentence from a large language model based on the input sentence; and
an outputter that outputs the answer sentence or a notification,
wherein the outputter outputs an answer sentence including the status information of the information processing apparatus when the input sentence is an inquiry about a status of the information processing apparatus.

2. The system according to claim 1, wherein the outputter outputs an answer sentence including a status display method when the input sentence is an inquiry about a status of the information processing apparatus that is not included in the status information of the information processing apparatus.

3. The system according to claim 1, wherein the outputter outputs a notification that there is an abnormality in the status of the information processing apparatus when there is an abnormality in the status information.

4. The system according to claim 3, wherein the outputter outputs a notification that there is an abnormality in the status of the information processing apparatus regardless of content of the input sentence when there is an abnormality in the status information.

5. The system according to claim 3, wherein the outputter outputs a notification that there is an abnormality in the status before the receiver receives the input sentence.

6. The system according to claim 1, further comprising:
a generator that generates a prompt based on the input sentence,
wherein the generator generates a prompt for determining whether the input sentence is an inquiry about the status of the information processing apparatus.

7. The system according to claim 6, wherein the generator further generates a prompt based on the input sentence and the status information of the information processing apparatus when the input sentence is an inquiry about the status of the information processing apparatus.

8. The system according to claim 1,
wherein the status information acquirer acquires the status information from the information processing apparatus,
the receiver receives an input sentence from a terminal apparatus, and
the terminal apparatus receives the input sentence after acquiring identification information.

9. A system comprising an information processing apparatus, a terminal apparatus, and a server apparatus,
wherein the information processing apparatus transmits status information of the information processing apparatus to the server apparatus,
the terminal apparatus receives an input sentence and transmits the input sentence to the server apparatus,
the server apparatus acquires an answer sentence based on the input sentence from a large language model,
the server apparatus transmits the answer sentence to the terminal apparatus, and
the terminal apparatus outputs an answer sentence including the status information of the information processing apparatus when the input sentence is an inquiry about a status of the information processing apparatus.

10. A control method comprising:
acquiring status information of an information processing apparatus;
receiving an input sentence;
acquiring an answer sentence from a large language model; and
outputting the answer sentence or a notification,
wherein the outputting includes outputting an answer sentence including the status information of the information processing apparatus when the input sentence is an inquiry about a status of the information processing apparatus.

11. A non-transitory computer-readable recording medium having a program recorded thereon that causes a computer to implement:
a status information acquisition function of acquiring status information of an information processing apparatus;
a reception function of receiving an input sentence;
an answer acquisition function of acquiring an answer sentence from a large language model; and
an output function of outputting the answer sentence or a notification,
wherein the output function includes outputting an answer sentence including the status information of the information processing apparatus when the input sentence is an inquiry about a status of the information processing apparatus.
